(19) United States
(12) Patent Application Publication
(10) Pub. No.: US 2008/0113183 A1
(43) Pub. Date: May 15, 2008

(54) High contrast sphere-supported thin-film electroluminescent devices

(76) Inventors: Adrian Kitai, Mississauga (CA); Yunxi Shi, Hamilton (CA); Yingwei Xiang, Hamilton (CA)

Correspondence Address: Ralph A. Dowell of DOWELL & DOWELL P.C., 2111 Eisenhower Ave, Suite 406, Alexandria, VA, 22314, US

(21) Appl. No.: 11/790,683

(22) Filed: Apr. 26, 2007

Related U.S. Application Data
(60) Provisional application No. 60/795,050, filed on Apr. 26, 2006.

(51) Int. Cl. B05D 5/12; B32B 15/00

(52) U.S. Cl. 428/332; 428/469; 428/432; 428/434; 427/66

(57) ABSTRACT

A two layer AR coating system for improving the contrast ratio of SSTFEL and Nixel devices. It is composed of an ITO layer and ultra-thin gold layer deposited on the surface of the EL devices. Thus the antireflection layer for a flexible emissive electroluminescent (EL) device comprises a layer of indium tin oxide (ITO) covering the surface of a flexible emissive electroluminescent device, and a layer of metal on top of the layer of indium tin oxide covering the surface of a flexible emissive electroluminescent device. The thicknesses of the layers may be adjusted to give destructive interference.

### CROSS REFERENCE TO RELATED UNITED STATES PATENT APPLICATION

This application claims the benefit of U.S. Provisional Application No. 60/795,050 entitled HIGH CONTRAST OF SPHERE-SUPPORTED THIN FILM ELECTROLUMINESCENT DISPLAYS, filed Apr. 26, 2006, which is incorporated herein by reference in their entirety.

### FIELD OF THE INVENTION

The present invention relates to a two-layer anti-reflection coating for flexible emissive thin film electroluminescent devices. The coating also serves to increase the contrast ratio of an electroluminescent display.

### BACKGROUND OF INVENTION

In a growing information society, individuals are linked to information through a variety of hardware interfaces. At least 90 percent of information we acquire is visual. The display as an output device bridges transfer of information between electronic devices and human beings, and, unlike other information processing devices, performs as a man-machine interface by interpreting analog and digital information signals. Because of this unique feature, a display needs to have human-compatible characteristics to be fully functional.

More than 100 years have passed since Braun invented the cathode ray tube (CRT) as a display device in 1897. Although drastic changes in the electronics world and in display technologies have been introduced based on various operating principles, no other technology in the display field has remained as successful for such a long time as the CRT with an established status as a high-performance and cost-effective device used for TVs and PC monitors. However, CRTs are reaching their performance limit due to the restriction of screen size. Although effort is still being devoted to enlarging its size and reducing depth, a move from bulky CRT displays toward thinner, lighter, flat panel displays (FPDs), such as Liquid Crystal Displays (LCDs) and Plasma displays (PDPs), has been underway in recent years. In the consumer market now, people are increasingly choosing the flat LCD and plasma TVs, not only for the space-saving potential and the enhanced appearance but also for their high contrast and quality images and resolution. However, while these display technologies are being developed and enhanced, research is starting on larger displays as well as flexible displays.

Flexible Display Technologies

The move from CRTs to FPDs has resulted in significant space savings, and enhanced mobility, as in the case of the laptop computer. A flexible display is expected to have the next significant impact in the field of displays in which rigid glass sheets are no longer required. Several flexible displays have been prototyped, such as reflective liquid crystal displays, OLED (organic light emitting display) displays, sphere-supported thin-film electroluminescence (SSTFEL) devices as taught in U.S. patent application Ser. No. 10/570,516 which is hereby incorporated in its entirety by reference, and a ceramic chip (nixel)-based EL display as taught by U.S. application Ser. No. 11/526,661 which is hereby incorporated in its entirety by reference.

The reflective mode of liquid crystals, in which the reflectance of ambient light is modulated to display images, can be utilized to make LCDs as flexible displays. Recently, color TFT-LCD and amorphous-silicon active-matrix panels have been demonstrated on a plastic substrate. However this kind of flexible display does not always have enough brightness since it does not emit light.

Based on self-luminous and plastic properties, OLED displays can be made on flexible substrates with enough brightness to show good quality images. However, they are very sensitive to moisture and oxygen and degrade if exposed to either. The challenge now is to find new organic materials with less sensitivity to moisture and oxygen, or to develop a gas and vapor protected flexible substrate or flexible seal technologies for displays.

Sphere-supported thin-film electroluminescence (SSTFEL) and Nixel technology are new platforms developed to fabricate a flexible display and taught in U.S. patent application Ser. Nos. 10/570,516 and 11/526,661, respectively, which are hereby incorporated in their entirety by reference.

The basic structure of the SSTFEL device disclosed in U.S. patent application Ser. No. 10/570,516 is shown in FIG. 1(a). On the top areas of ceramic (BaTiO₃) spheres is a sandwich structure composed of two charge injection (alumina, silicon oxynitride for example) layers and a thin-film oxide or sulfide EL phosphor (such as Zn₂Si_{0.5}Ge_{0.5}O₄:Mn, ZnS:Mn, SrS:Cu) layer. Two electrodes are made by depositing a metal (gold, copper, aluminum, or nickel, for example) layer on the rear of the device and a transparent conductive layer (such as indium-tin oxide, zinc oxide, and aluminum doped zinc oxide) on the emissive side of the device to form a thin-film electroluminescence (TFEL) structure. Alternatively, the one or both of the charge injection layers may be omitted. The spheres are embedded within a flexible polymer (such as polypropylene or polyester) sheet to become light-emitters under the application of an AC voltage.

The Nixel ceramic chip configuration disclosed in U.S. patent application Ser. No. 11/526,661 is shown in FIG. 1(b). The nixel includes a ceramic substrate, a first charge injection layer on an upper surface of the ceramic substrate, a phosphor layer on top of the first charge injection layer, a second charge injection layer on top of the phosphor layer, an upper electrode on the upper surface of the second charge injection layer and a lower electrode on the lower surface of the ceramic substrate. In an alternative embodiment, the first and/or second charge injection layer(s) may be eliminated. The nixels may be coupled to a flexible substrate to form a flexible display. An individual nixel may be manufactured independently of other nixels prior to being integrated into a display unit, and can be tested and sorted according to predetermined performance characteristics. A nixel may be adapted to be joined with other nixels to form a pixel, a subpixel or a plurality of pixels or subpixels for an EL display. The nixel can be formed in a variety of shapes and sizes to suit a variety of EL display applications, and each nixel may be manufactured separately and processed according to its own manufacturing requirements.

Unlike other flexible display technologies, the SSTFEL and Nixel devices based on TFEL technology are self-luminous display technologies and have the advantage of not being sensitive to humidity and air. In a thin-film EL (TFEL) display, the light-emitting layer is only about 0.5 μm to 1.0 μm thick, and total device thickness is about 1-2 μm. Driving voltages are AC voltage. The basic structure of TFELs consists of 5 layers shown in FIG. 2(a). The middle layer is the phosphor layer, which is typically made from sulfide-based materials; however, oxide-based materials may also be used. Light is emitted from a TFEL device when a voltage is applied on the device and the electric field across the thin film stack reaches a threshold strength of about 10⁶ (V/cm). Under the application of the voltage, electrons tunnel from interface states at the dielectric/phosphor interface, shown in FIG. 2(b), and then are accelerated by the high electric field of about 10⁶ (V/cm) in the phosphor layer. Once the electrons gain enough energy from the electric field they can impact-excite luminescent centers to emit light and ionize electrons from atoms to create avalanche current. When electrons reach the opposite side of the phosphor layer, they are trapped at interface states. They will be released again when the applied voltage is reversed; then the same process is repeated in reverse.

The devices can be modeled as a pair of back-to back Zener diodes connected to two series capacitors as shown in FIG. 3: Cᵢ is an equivalent capacitor of the dielectric layer; and Cₚ, is an equivalent capacitor of the phosphor layer. Under an applied voltage Vₐ to the device, the voltage applied to the phosphor layer Vₚ is expressed as

$${V}_{p} = \frac{1}{1 + \frac{{ɛ}_{p} {d}_{i}}{{ɛ}_{i} {d}_{p}}} {V}_{a} \qquad ( 1 )$$

and luminance (L) of devices

$${L}_{EL - on} = \frac{4}{π} η f {ɛ}_{0} {ɛ}_{i} ( \frac{{d}_{p}}{{d}_{i}} ) {E}_{p , th} ( {V}_{a} - {V}_{th} ) \qquad ( 2 )$$

Where ∈ᵢ, ∈ₚ are the related dielectric constant of dielectric layer and phosphor layer, respectively; dᵢ, dₚ are the thickness of dielectric layer and phosphor layer, respectively; f is the frequency of an AC applied voltage; and η is the luminous efficiency of the phosphor layer. From equations (1) and (2), there are two methods by which the luminance of the device may be improved under a constant modulation voltage (Vₐ-Vₜₕ). One way is to maximize the thickness of the phosphor layer relative to the dielectric layer and use the dielectric layer with a high dielectric constant, such as BaTiO₃ with ∈ᵢ˜2000-4000. The other important method is to increase the luminous efficiency of the phosphor layer, 77.

### PRIOR ART ANTI-REFLECTIVE COATINGS AND CONTRAST ENHANCEMENT

All display screens have specular and diffuse reflections that can degrade image contrast and affect image quality. They generally require a contrast enhancing technology to improve visual performance. Anti-reflectance (AR) coatings are most widely used for enhancing the contrast of displays. They can effectively reduce the specular and diffuse reflection of ambient light on the surface or interfaces in a display system. In CRT displays and flat panel displays such as PDPs and field effect devices (FED), AR coatings are deposited on the surface of the glass screen to reduce reflection of ambient light and to enhance the contrast of images.

Two other kinds of contrast enhancement technologies have been demonstrated in order to reduce the reflection of ambient light from EL displays, including OLED. In EL displays, light emitting material, such as sulfide or oxide-based materials in the inorganic EL display, and organic self-luminous materials, in the OLED are transparent. At the front of display devices, an Indium Tin Oxide (ITO) film is often deposited to work as a conductive and transparent electrode, which allows transmission of the emitting light. Therefore, ambient light not only reflects from the surface of the EL display but also can pass though the ITO layer and light emitting materials and reflects strongly from the back metal electrode of devices. Both reflections degrade the contrast of displays. Therefore, reducing reflection from the back electrode is integral to enhancing the contrast of EL displays; this can be accomplished by introducing a black electrode to the back of the device. One kind of black cathode has been developed by Xerox Company. It is an absorbing and conducting cathode to be put on the back side of organic layers. Another black cathode is a new generation of black metal conducting layers developed by Luxell and applied on the backside of OLEDs to reduce the reflection of ambient light.

Because an electrode layer on SSTFEL and Nixel device surfaces is composed of a 30 nm gold layer and an ITO layer with very high reflectance in visible wavelengths of about 40% and 11% respectively, obviously the devices have very high reflectance due to the direct reflection of the gold layer. Thus, the flexible emissive thin film electroluminescent devices suffer from low contrast under ambient illumination and need AR coatings to enhance contrast.

There are also two types of reflections while light is incident on the surface of SSTFEL display devices, namely specular reflection and diffuse reflection. For SSTFEL devices, surface reflection is complicated due to the special structure of the SSTFEL device shown in FIG. 1(a). The surface of the SSTFEL device is composed of two areas: the area of region A. on the surface of the device is composed of a 30 nm gold layer and an ITO layer deposited on the smooth surface of the polypropylene sheet with a minor roughness and exhibits predominately specular reflection as shown in FIG. 4(a); the area of region B the spherical surface of BaTiO₃ spheres embedded within the polypropylene sheet exhibits predominantly diffuse reflection as shown in FIG. 4(b). It is known that an ITO layer, Al₂O₃ layers and phosphor layer deposited on the top area of BaTiO₃ spheres are all transparent, and the surface of BaTiO₃ spheres is white with high reflectance. Therefore, the diffuse reflection from region B is very high under ambient illumination. The reflection behavior of a Nixel-based El device is shown in FIG. 4(c). Therefore the need exists for AR coatings for reducing the ambient light reflection including specular and diffuse reflections from the surface of flexible thin film EL devices in order to enhance the contrast ratio of flexible EL devices.

### Fresnel Equations

Fresnel equations express the ratio of both reflected and transmitted E-field amplitudes to the incident E-field amplitude when light is incident on the surface or the interface of dielectric materials. Let us assume a ray of light incident at point P on an interface on the xz-plane. FIG. 7 shows the resulting reflected and refracted rays. The plane of incidence is xy-plane. The incident light is assumed a plane harmonic wave expressed as

\vec{E}ᵢ=\vec{E}₀e^{i(\vec{k}·\vec{r}-ωt)} (3)

### The reflected and transmitted waves in FIG. 7 can be expressed, respectively, as

\vec{E}ᵣ=\vec{E}₀ᵣe^{i(\vec{k}}^{ᵣ}^{·\vec{r}-ω}^{ᵣ}^{t)} (4)

\vec{E}ₜ=\vec{E}₀₂e^{i(\vec{k}}^{ₜ}^{·\vec{r}-ω}^{ₜ}^{t)} (5)

In the interface plane xz, where all three waves exist simultaneously, their relationship cannot depend on the arbitrary choice of a boundary point r or a time t, and should be fixed. The phases of the three waves, which depend on r and t, must themselves be equal:

(\vec{k}ᵢ·\vec{r}−ωt)=(\vec{k}ᵣ·\vec{r}−ωᵣt)=(\vec{k}ₜ·\vec{r}−ωₜt) (6)

### This equation yields

ωᵢ=ωᵣ=ωₜ (7)

and \vec{k}ᵢ·\vec{r}=\vec{k}ᵣ·\vec{r}=\vec{k}ₜ·\vec{r} (8)

where kᵣ=nᵣω/c, and kₜ=nₜω/c. The first two terms and last two terms of Eq. (8) become

law of reflection: θᵢ=θᵣ (9)

and Snell's law of refraction: n₁ sin θᵢ=n₂ sin θₜ (10)

With the help of boundary conditions arising out of Maxwell's equations, the requirement of these boundary conditions for the electric fields of transverse electric (TE) mode:

Eᵢ+Eᵣ=Eₜ (11)

### In the case of the corresponding magnetic fields,

Bᵢ cos θᵢ−Bᵣ cos θᵢ=Bₜ cos θₜ (12)

When we parallel their development for the transverse magnetic (TM) mode, we have

Bᵢ+Bᵣ=Bₜ (13)

−Eᵢ cos θᵢ+Eᵣ cos θᵣ=−Eₜ cos θₜ (14)

### For non-magnetic material, the magnetic field in the above equations can be expressed in terms of electric field through the relation

$$B = \frac{n}{c} E , ( n = {n}_{2} / {n}_{1} ) \qquad ( 15 )$$

The reflection coefficient r=Eᵣ/E and transmission coefficient t=Eₜ/E are obtained from simplifying Eq. (9) through (14)

$$\begin{matrix}TE \text{:} r = \frac{{E}_{r}}{{E}_{i}} = \frac{{n}_{1} cos {θ}_{i} - {n}_{2} cos {θ}_{t}}{{n}_{1} cos {θ}_{i} + {n}_{2} cos {θ}_{t}} & ( 16 ) \\ TM r = \frac{{E}_{r}}{{E}_{i}} = \frac{{n}_{2} cos {θ}_{i} - {n}_{1} cos {θ}_{t}}{{n}_{2} cos {θ}_{i} + {n}_{1} cos {θ}_{t}} & ( 17 ) \\ TE \text{:} t = \frac{{E}_{t}}{{E}_{i}} = \frac{2 {n}_{1} cos {θ}_{i}}{{n}_{1} cos {θ}_{i} + {n}_{2} cos {θ}_{t}} & ( 18 ) \\ TM \text{:} t = \frac{{E}_{t}}{{E}_{i}} = \frac{2 {n}_{1} cos {θ}_{i}}{{n}_{2} cos {θ}_{i} + {n}_{1} cos {θ}_{t}} & ( 19 )\end{matrix}$$

Equations (16) through (19) are the Fresnel equations, which express the ratio of both reflected and transmitted E-field amplitudes to the incident E-field amplitude by reflection and transmission coefficients. The reflectance and transmittance, respectively, for TE and TM modes of light incident on the surface of the dielectric material are

$$\begin{matrix}{R}_{TE} = {r}_{TE}^{2} ; {T}_{TE} = 1 - {R}_{TE} & ( 20 ) \\ {R}_{TE} = {r}_{TE}^{2} ; {T}_{TE} = 1 - {R}_{TE} & ( 21 )\end{matrix}$$

When the reflecting surface is metallic, the Fresnel equations continue to be valid, but the index of homogeneous dielectric materials with conductivity zero will be replaced by the complex index of the metal. The complex index of the metal is a composite of two parts: one is a real part, the other is an imaginary part associated with its conductivity and energy absorbance.

The complex index, in general, is expressed as

ñ=n_{R}+in₁ (22)

### Therefore, Fresnel equations become

$$\begin{matrix}TE \text{:} r = \frac{{E}_{r}}{{E}_{i}} = \frac{{\tilde{n}}_{1} cos {\tilde{θ}}_{i} - {\tilde{n}}_{2} cos {\tilde{θ}}_{t}}{{\tilde{n}}_{1} cos {\tilde{θ}}_{i} + {n}_{2} cos {\tilde{θ}}_{t}} & ( 23 ) \\ TM r = \frac{{E}_{r}}{{E}_{i}} = \frac{{\tilde{n}}_{2} cos {\tilde{θ}}_{i} - {\tilde{n}}_{1} cos {\tilde{θ}}_{t}}{{\tilde{n}}_{2} cos {\tilde{θ}}_{i} + {\tilde{n}}_{1} cos {\tilde{θ}}_{t}} & ( 24 ) \\ TE \text{:} t = \frac{{E}_{t}}{{E}_{i}} = \frac{2 {\tilde{n}}_{1} cos {\tilde{θ}}_{i}}{{\tilde{n}}_{1} cos {\tilde{θ}}_{i} + {\tilde{n}}_{2} cos {\tilde{θ}}_{t}} & ( 25 ) \\ TM \text{:} t = \frac{{E}_{t}}{{E}_{i}} = \frac{2 {\tilde{n}}_{1} cos {\tilde{θ}}_{i}}{{\tilde{n}}_{2} cos {\tilde{θ}}_{i} + {\tilde{n}}_{1} cos {\tilde{θ}}_{t}} & ( 26 )\end{matrix}$$

### Basic Theory of Anti-Reflection Coating

Anti-reflection coatings are used to reduce the surface reflectance of optical components and the reflectance of an interface between two media with different refractive indices. The ideal AR coating is a set of very thin homogeneous layers with refractive indices increasing in small steps from the low index medium to the high-index medium. This coating is of no practical value because there are limits to choices of materials, which can be deposited as hard and environmentally stable coatings. Single-layers and multi-layers have been utilized as a substitute method to make AR coatings.

### Single-Layer Anti-Reflection Coating

A single-layer AR coating optical system is shown in FIG. 6. The reflectance of this system, the normal incidence, is expressed as (Macleod, H. A., Thin-Film Optical Filters, ed. W. T. Welford, Adam Hilger Ltd., Bristol, England, 1986.)

$$R = \frac{{{n}_{1}^{2} ( {n}_{0} - {n}_{s} )}^{2} {cos}^{2} δ + ( {n}_{0} {n}_{s} - {n}_{1}^{2} ) {sin}^{2} δ}{{{n}_{1}^{2} ( {n}_{0} + {n}_{s} )}^{2} {cos}^{2} δ + ( {n}_{0} {n}_{s} + {n}_{1}^{2} ) {sin}^{2} δ} \qquad ( 27 )$$

where n₀, n₁, and n₂ express the index of air, a dielectric layer and a substrate respectively. δ is the optical path difference of the film given by

$$δ = \frac{2 π}{{λ}_{0}} ( {n}_{1} {d}_{1} ) \qquad ( 28 )$$

### When the thickness of the film is a quarter wavelength, d₁=λ4, where λ is the light wavelength in the film, then δ=π/2, and

$$R = {( \frac{{n}_{0} {n}_{s} - {n}_{1}^{2}}{{n}_{0} {n}_{s} + {n}_{1}^{2}} )}^{2} \qquad ( 29 )$$

It is obvious that a perfectly non-reflecting film can be made with a coating of λ/4 and refractive index n₁=\sqrt{n₀nₛ}. When n₁<\sqrt{n₀nₛ} or n₁>\sqrt{n₀nₛ}, the reflectance cannot be zero even if the thickness of the film is equal to quarter-wavelength. When the substrate is glass with nₛ=1.52, the ideal index for a nonreflecting coating is n₁=1.23, shown in FIG. 7. Therefore, there are two ways to tune the reflectance. One way is to modify the film thickness. When the thickness of the film is equal to quarter-wavelength in optical path difference, the phase difference between two reflected light beams shown in FIG. 8 is 180 degrees and the maximum destructive interference between two beams could occur. Reflectance, R, will be a minimum. Another way to tune the reflectance is to change the index of the film to modify the amplitudes of the electric field of two reflected light beams. When the electric field amplitudes of two reflected light beams is equal but reverse, both of them cancel out resulting in a reflectance, R, of zero.

If the index of the film does not match the value of \sqrt{n₀nₛ}, a thin metallic film can be utilized to compensate by depositing it on the top of the film or in the film/substrate interface. This method has been used in this work and will be described in the following section in detail.

### Contrast Ratio of Displays

Display screens can often be modeled to consist of three parts: the front, middle and back parts shown in FIG. 8. Each part comprises the components that are located in front, within and behind the display. (T₁, R₁, A₁), (T₂, R₂, A₂), and (T₃, R₃, A₃) represent a transmittance (T), reflectance (R) and absorption (A) related to each part respectively. Here, T R, and A take into account possible factors, such as the size of pixel apertures, specular or diffuse reflection, and scattering.

The luminance contrast ratio of a display is defined to be the ratio of the total luminance of the light from the “on” pixel to the total luminance of the light from the “off” pixels.

$$C = \frac{{L}_{pixel \text{-} on}}{{L}_{pixel \text{-} off}} = \frac{{L}_{EL \text{-} on} + {L}_{reflect}}{{L}_{El \text{-} off} + {L}_{reflect}} \qquad ( 30 )$$

In the above equation, Lₚᵢₓₑₗ₋ₒₙ expresses the luminance of light output from the device with the pixel “on”. For the SSTFEL device, it is the sum of L_{EL-on} and L_{reflect}. L_{EL-on} is luminance of light from pixels of the device under the application of an AC voltage and expressed in Eq. 2, and L_{reflect} is the reflection luminance of ambient light from the surface of displays, which is a product of the reflectance of devices and the illuminance of ambient light, R*L_{ambient}; L_{pixel-off} expresses luminance of light output from the device with the pixel “off”, which is the sum of L_{EL-off} and L_{reflect}. L_{EL-off} is equal to zero due to no light emitted from pixels of the device without the application of an AC voltage. To replace L_{reflect} with R*L_{ambient}, and L_{EL-on} with the equation (2) in equation (30), it becomes

$$C = \frac{η}{R} ( \frac{1}{{L}_{ambient}} ) \{ \frac{4}{π} f {ɛ}_{0} {ɛ}_{i} ( \frac{{d}_{p}}{{d}_{i}} ) {E}_{p , th} ( {V}_{a} - {V}_{th} ) \} + 1 \qquad ( 31 )$$

It is clear that removing the reflection from the surface and interface is a very effective way to enhance the contrast of displays because this reflection determines the influence of the ambient light on the contrast. R is inversely proportional to contrast ratio of EL devices such as SSTFEL devices. Table 1 lists some of the optical coatings used for this purpose. The other way is to increase η of the device. Both of these methods increase the contrast ratio of the device. It can be seen that contrast ratio is also a parameter relevant to the ambient illuminance level of measurement conditions for EL display devices.

TABLE 1
OPTICAL COATINGS FOR CONTRAST ENHANCEMENT

| | Display types | | |
|---|---|---|---|
| | | Non-emissive | Non-emissive |
| | Emissive | Transmissive | Reflective |
| Reduce R₁ | AR coating | AR coating | AR coating |
| Reduce R₂ | AR coating | AR coating | AR coating |
| | Black coating | | |
| Reduce R₃ | AR or | AR coating | AR or |
| | Black coating | | Black coating |

AR: anti-reflectance

### SUMMARY OF THE INVENTION

In this invention, a two layer AR coating system was selected for improving the contrast ratio of SSTFEL and Nixel devices. It is composed of an ITO layer and ultra-thin gold layer deposited on the surface of the EL devices as shown in FIG. 10.

For this AR coating on the area of part A, the polymer area which is shown in FIGS. 10(a) and (b), the ITO layer works as a phase tuner to make a phase difference of almost 180 degrees between two reflective light beams (R1, R2). The ultra-thin gold layer is utilized to adjust the intensity of reflectance light R1 to match closely the intensity of R2 in order to reduce reflectance. On the area of part B, the phosphor-coated area on top of a ceramic sphere or chip, which is shown in FIGS. 10(a) and (b), respectively, the ultra-thin gold layer, the ITO layer, two Al₂O₃ layers and the phosphor layers form an optical system. The thickness of the ultra-thin gold layer, the ITO layer and Al₂O₃ layers could be optimized to reduce the diffuse reflectance light from top areas of BaTiO₃ spheres. It has been reported that the ultra-thin gold layer and the ITO layer can work as AR coatings to reduce specular reflection effectively and enhance the contrast ratio of the electroluminescent device made on planar BaTiO₃ chips. The coating of this invention may be optimized in thickness/sputtering time, RF power, and sputter chamber pressure for other pixel arrangements, such as three-dimensional BaTiO₃ shapes (including but not limited to cubic, cylindrical, conical, and pyramidal) and two-dimensional BaTiO₃ chips of any shape (for example, triangular, pentagonal, hexagonal, etc).

### BRIEF DESCRIPTION OF THE DRAWINGS

The invention will be more fully understood from the following detailed description thereof taken in connection with the accompanying drawings, which form part of this application, and in which:

FIG. 1 shows Prior Art (a) schematic SSTFEL and (b) Nixel structure diagrams.

FIG. 2 shows (a) a schematic diagram of basic device structure and (b) principle of the electroluminescence (EL) process.

FIG. 3 shows a schematic diagram of the equivalent circuit of TFEL devices.

FIG. 4 shows schematic diagrams of (a) specular and diffuse reflections from the surface of the (b) SSTFEL and (c) Nixel devices without AR coatings.

FIG. 5 shows a defining diagram of incident (kᵢ), reflected (kᵣ), and transmitted (kₜ) rays at a XZ-plane interface when the electric field is the transverse electric (TE) mode.

FIG. 6 shows a schematic diagram of a single-layer AR coating system, and light rays transmitted and reflected by this film when multiple reflections are neglected.

FIG. 7 shows the reflectance from a single film layer versus normalized path difference. The dashed line represents the uncoated glass substrate of index nₛ=1.52.

FIG. 8 shows schematic structures of simplified displays. (A) expresses emissive displays including CRTs, PDPs, FEDs, and TFELs; (B) for the case of transmissive LCDs; and (C) for reflective LCDs.

FIG. 9 shows schematic diagrams of (a) specular, and diffuse eflections from (b) the surface of the SSTFEL and (c) Nixel devices with AR coatings.

FIG. 10 shows the structure of (a) SSTFEL and (b) Nixel EL devices with AR coatings.

FIG. 11 shows an SSTFEL device with AR coating under office illumination.

FIG. 12 shows thickness of ITO films versus sputtering time under different RF Powers.

FIG. 13 shows deposition rates of ITO films versus RF power.

FIG. 14 shows deposition rates of ITO films versus chamber pressure.

FIG. 15 shows resistivity of ITO films versus RF power under sputtering conditions with chamber pressure of 0.5 mTorr and Ar flow ratio of 7.0 sccm.

FIG. 16 shows resistivity of ITO films versus the chamber pressure under sputtering conditions with RF power of 30 W and Ar flow ratio of 7.0 sccm.

FIG. 17 shows the reflective index of ITO films fabricated under different RF powers with different thickness.

FIG. 18 shows the reflective index of ITO films versus the RF power under sputtering conditions with the chamber pressure of 0.5 mTorr and Ar flow ratio of 7.0 sccm.

FIG. 19 shows the reflective index of ITO films versus the chamber pressure under sputtering conditions with RF power of 30 W and Ar flow ratio of 7.0 sccm.

FIG. 20 shows the transmittance spectra of ITO films with different thickness but deposited at the same RF power of 30 W and the same chamber pressure of 0.5 mTorr.

FIG. 21 shows the transmittance spectra of ITO films deposited under different chamber pressures, but at the same RF power of 30 W and the same sputtering time of 6 minutes.

FIG. 22 shows the transmittance spectra of ITO films deposited under different chamber pressures, but the same RF power of 30 W and the same sputtering time of 6 minutes.

FIG. 23 shows AFM images scanned over 1×1 μm² on ultra-thin gold films sputtered on Si substrates ranging from (a) 5 seconds (or 5″), (b) 8 seconds (or 8″), (c) 18 seconds (or 18″), (d) 25 seconds (or 25″), and (e) 40 seconds (or 40″). Each group has four images except for FIG. 23(e): Three are AFM images viewed from different angles, one is the thickness measurement result of the ultra-thin gold films.

FIG. 24 shows the thickness of ultra-thin gold film versus the sputtering times.

FIG. 25 shows images of AFM scanned over 500×500 nm² of ultra-thin gold films sputtered on the surface of ITO layer on Si substrates ranging (a) 7 seconds (or 7″), (b) 10 seconds (10″), (c) 15 seconds (15″), (d) 25 seconds (25″), and (e) 35 seconds (35″). (f) is the image of ultra-thin gold films sputtered on the surface of ITO layer on a polypropylene sheet. Each group has two images viewed from top and side views.

FIG. 26 shows sheet resistance of ultra-thin films with sputtering time ranging from 3 second to 60 second.

FIG. 27 shows reflection spectra of ultra-thin gold films on Si substrates with sputtered time ranging from 5 second (5″) to 5 minutes (5′). In-set shows reflection spectrum of bulk gold with polished surfaces.

FIG. 28 shows reflection spectra of ultra-thin gold films on glass slide substrates with sputtered time ranging from 5 seconds (5″) to 5 minutes (5′).

FIG. 29 shows transmittance spectra of ultra-thin gold films on glass slide substrates with sputtering time ranging from 5 seconds (5″) to 5 minutes (5′).

FIG. 30 shows specular reflectance spectra of samples with a ITO film of 100 nm on Au2′/pp and without a ITO film on Au2′/pp.

FIG. 31 shows specular reflectance spectra of samples with different thickness of AR coating layers on Au2′/pp, organized based on the sputtering time of ITO layers.

FIG. 32 shows specular reflectance spectra of samples with different thickness of AR coating layers on Au2′/pp, organized based on the sputtering time of ultra-thin gold layers.

FIG. 33 shows lower reflectance spectra of samples in FIG. 32 with different thickness of AR coating layers on Au2′/pp.

FIG. 34 shows diffuse reflectance spectra of samples with different thickness of AR coating layers on Au2′/pp, organized based on the sputtering time of ITO layers.

FIG. 35 shows diffuse reflectance spectra of samples with different thickness of AR coating layers on Au2′/pp, organized based on the sputtering time of ultra-thin gold layers.

FIG. 36 shows lower reflectance spectra of samples in FIG. 35 with different thickness of AR coating layers on Au2′/pp.

FIG. 37 shows specular reflectance spectra of SSTFEL devices with or without AR coatings.

FIG. 38 shows diffuse reflectance spectra of SSTFEL devices with or without AR coatings.

FIG. 39 shows a schematic diagram of the model for AR coatings on polypropylene sheets.

FIG. 40 shows a schematic diagram of AR coating on gold layer with thickness of 360 nm.

FIG. 41 shows schematic diagrams of the transmittance measurement of ITO films deposited on glass slides by Cary 50 Probe UV Visible Spectrophotometer.

FIG. 42 shows schematic diagrams of the transmittance measurement of ultra-thin gold films on glass slides by Cary 50 Probe UV Visible Spectrophotometer.

FIG. 43 shows schematic diagrams of interface reflections between the air and a thick gold layer (a); and between the ITO layer and the thick gold layer (b).

FIG. 44 shows simulation results of specular reflectance of AR coatings composed of ultra-thin gold layer with sputtering time of 5 seconds and various ITO layers (a) to (g) as the parameter of Δ is changed from 0 to π. (h) is the measurement results of AR coatings composed of ultra-thin gold layer with sputtering time of 4 seconds and different ITO layers.

FIG. 45 shows simulation results of specular reflectance of AR coatings composed of ultra-thin gold layer with sputtering time of 12 seconds and various ITO layers (a) to (g) as the parameter of Δ is changed from 0 to π. (h) is the measurement results of AR coatings composed of ultra-thin gold layer with sputtering time of 11 seconds and different ITO layers.

### DETAILED DESCRIPTION

As required, specific embodiments of the invention are disclosed herein. It should be understood, however, that these are merely exemplary embodiments of the invention that can be variably practiced. Drawings are included to assist the teaching of the invention to one skilled in the art; however, they are not drawn to scale and may include features that are either exaggerated or minimized to better illustrate particular elements of the invention. Related elements may be omitted to better emphasize the novel aspects of the invention. Specific structural and functional details disclosed herein are not to be interpreted as limiting, but merely as a basis for the claims and as a representative basis for teaching one skilled in the art to variously employ the present invention.

As used herein, the term “about”, when used in conjunction with ranges of dimensions of particles or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

When practiced as a flexible EL display, the display elements can be formed as SSTFEL as taught by copending U.S. patent application Ser. No. 10/570,516, (U.S. Patent Publication No. 2007/0069642A1) which is hereby incorporated in its entirety by reference. Alternatively, the display elements can be formed as nixels, as discussed in U.S. patent application Ser. No. 11/526,661, which is hereby incorporated in its entirety by reference. While examples, data, and structures may be presented representing only one of these flexible emissive EL display types, it is understood that the invention may be equally applied to either display type.

### Structure of SSTFEL and Nixel Devices with AR Coatings

The structure of SSTFEL devices with AR coatings is schematically shown in FIG. 10(a). In an exemplary embodiment, thousands of tiny BaTiO₃ spheres (diameter in a range from about 53 to 60 μm see FIG. 10(a)) of high-permittivity dielectrics (∈ᵣ=1000-6000) are embedded within a polymer (polypropylene, polyester, etc.) sheet to form a flexible display. On the top area of the BaTiO₃ spheres, green-emitting oxide phosphor (Zn₂Si_{0.5}Ge_{0.5}O₄:Mn; other phosphors may be used) with thickness of 500˜700 nm is deposited by RF magnetron sputtering. Two 35 nm Al₂O₃ layers are deposited (sputtered for example) to sandwich this phosphor layer in order to provide charge-injection interfaces. A 45-50 nm thick ITO layer is deposited on the top area of the device to form a conductive and transparent electrode for light to leave from the green oxide phosphor under the application of an AC voltage. Under the ITO layer is a 30 nm gold layer for improving the stability of the conductivity of the ITO layer; the ITO layer on the polypropylene sheet is easily cracked due to the strain from the bent polypropylene sheet when the polypropylene sheet bends, resulting in a jump in resistance. This thick gold layer is deposited the Part A (polymer) regions. The AR coatings are comprised of the ITO layer and an ultra-thin gold layer that is deposited (one method being sputtering) directly on the surface of the ITO layer to enhance the contrast ratio of SSTFEL devices. The rear electrode of these devices is another gold layer with thickness of 30-60 nm, which is not visible to the viewer of the display.

FIG. 10(b) shows the structure of a Nixel device with an AR coating. Multiple Nixel ceramic chip substrates, such as BaTiO₃, are embedded in a flexible polymer (such as polypropylene or polyester). The chips may be the size of pixel or subpixel. In an exemplary embodiment, a gold layer is deposited on the top side of a chip and a phosphor layer is deposited on the top side of this gold layer (for example by RF magnetron sputtering). An Al₂O₃ charge injection layer is deposited both under and over the phosphor layer; and a 45-50 nm ITO layer is deposited over the entire device surface area to form a transparent conductive electrode through which light is emitted from the phosphor under AC voltage and a thin gold layer is included over this entire ITO surface. The gold layers advantageously act to improve stability and conductivity of the easily cracked ITO layer. The AR coating is composed of the ITO layer and an ultra-thin gold layer sputtered on the surface of the ITO layer and serves to enhance the contrast ratio of the EL device. The rear electrode is formed of another gold layer with a thickness of 30-60 nm.

### Fabrication Processes of SSTFEL and Nixel Devices with AR Coatings

The methods of manufacturing SSTFEL and Nixel devices are fully described in U.S. patent application Ser. No. 10/570,516 and 11/526,661, respectively, which are herein incorporated in their entirety by reference.

In order to make devices flexible, BaTiO₃ spheres or chips, as light emitters, are embedded within a thin and flexible polymer sheet. In an exemplary embodiment, the embedding process is separated into two steps: First, a 30 nm gold layer was deposited on a polypropylene sheet that was used to pick up the BaTiO₃ spheres or spheres. The polypropylene sheet was adhered on a silicone elastomer layer of a sheet that is composed of a hard, polyester backing sheet and a soft silicone elastomer layer, which is called Gel-Pak® film, made by Gel-Pak, Inc. This Gel-Pak® and polypropylene stack was pressed on BaTiO₃ spheres or chips covering an Al₂O₃ plate and heated in N₂ up to 200° C. BaTiO₃ spheres or chips penetrate the polypropylene sheet when the sandwich is vertically pressed under the pressure of 0.12N/cm², and then quickly cooled. While cooling to room temperature, the BaTiO₃ spheres or chips including dielectric and phosphor thin film layers are embedded tightly within the thin polypropylene sheet.

The second step is to push the thin polypropylene sheet into the middle of the BaTiO₃ spheres. The device was sandwiched between two Gel-Pak® films, heated up to 173° C., and then quickly cooled down to room temperature under a pressure of 2.21 N/cm² on this sandwich structure. Because the adhesive layer of Gel-Pak® film is elastic and deforms under pressure, it can effectively protect the top and bottom area of spheres from being covered with a polymer sheet. Moreover, the polypropylene sheet with embedded spheres could be easily peeled off from this adhesive layer without any damage.

### Sputtering AR Coating and Electrodes

A transparent ITO electrode layer with thickness about 45 nm is deposited on the top area of the device. The ITO target is an In₂O₃:SnO₂ (90:10 wt %) ceramic target and is pre-sputtered 5 minutes before the ITO layer deposition on the surface of devices. Typical sputtering conditions are shown in Table 2. The RF power must be lower than 30 W; if RF power is set at 45 W, the atoms of the target have more kinetic energy to impact on the surface of devices, which results in an increase of the temperature of the devices during the 4 minute sputtering process. As a result, the polymer sheet of devices will crack and wrinkle. The transparent ITO electrode layer deposited on the surface of the devices also works as a dielectric layer. This AR coating is a composite of this ITO layer and an ultra-thin gold layer with thicknesses of around 45 nm and 3.5 nm, respectively. The ultra-thin gold layer was sputtered on the surface of the ITO layer by Edwards Sputter Coater S150B. The sputtering is performed at a ratio of about 18 nm/min in 0.18 Torr Ar ambient with RF power of 30 W on a 99.99% gold target.

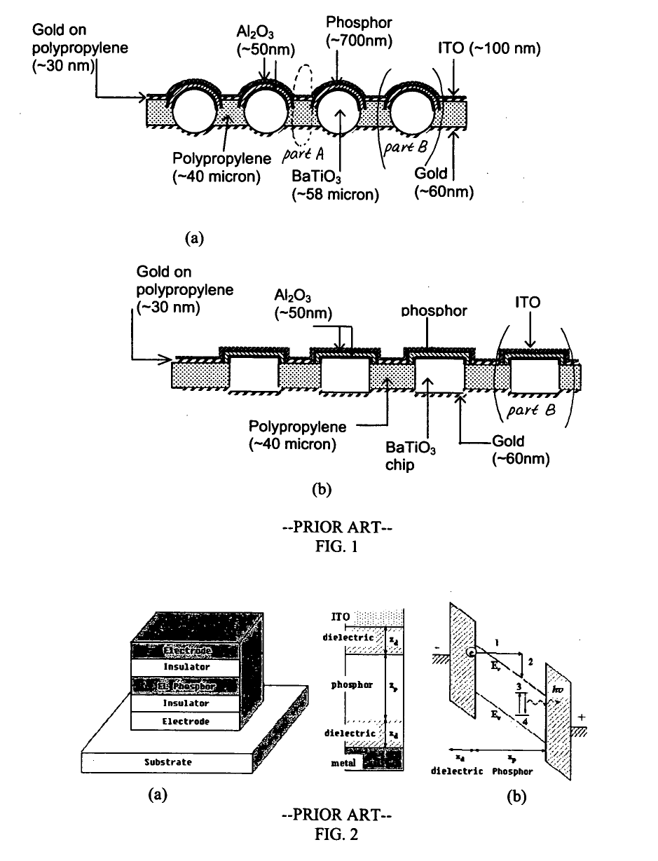

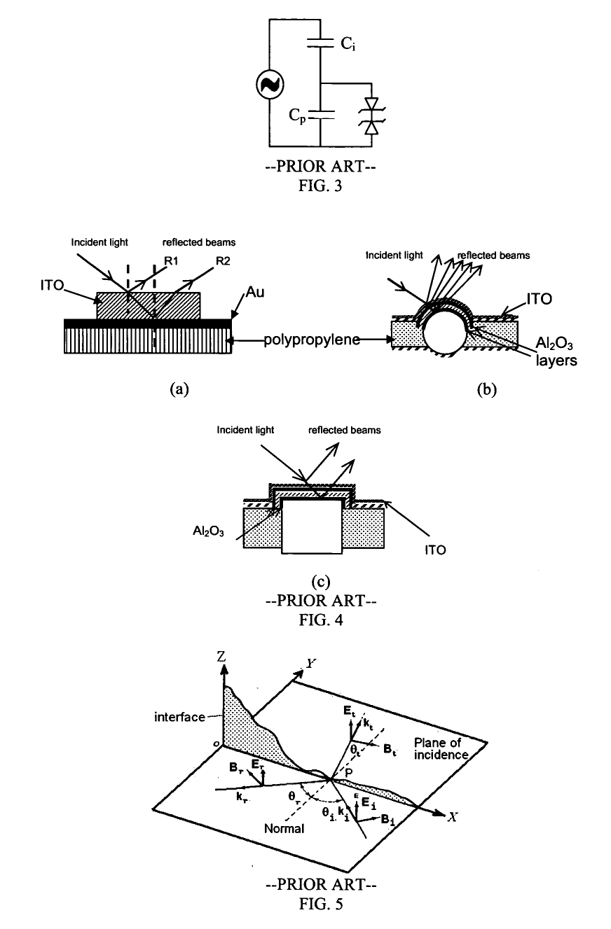

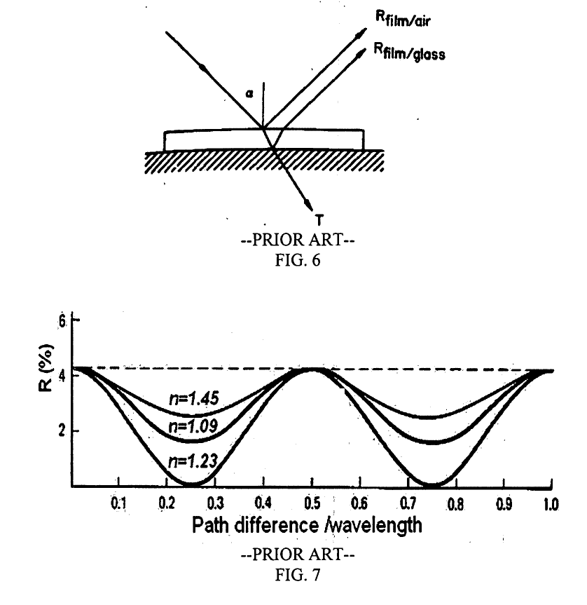

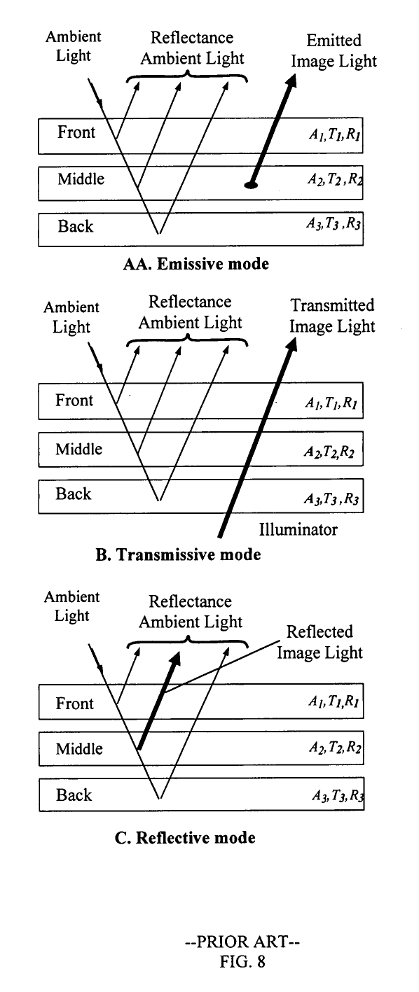

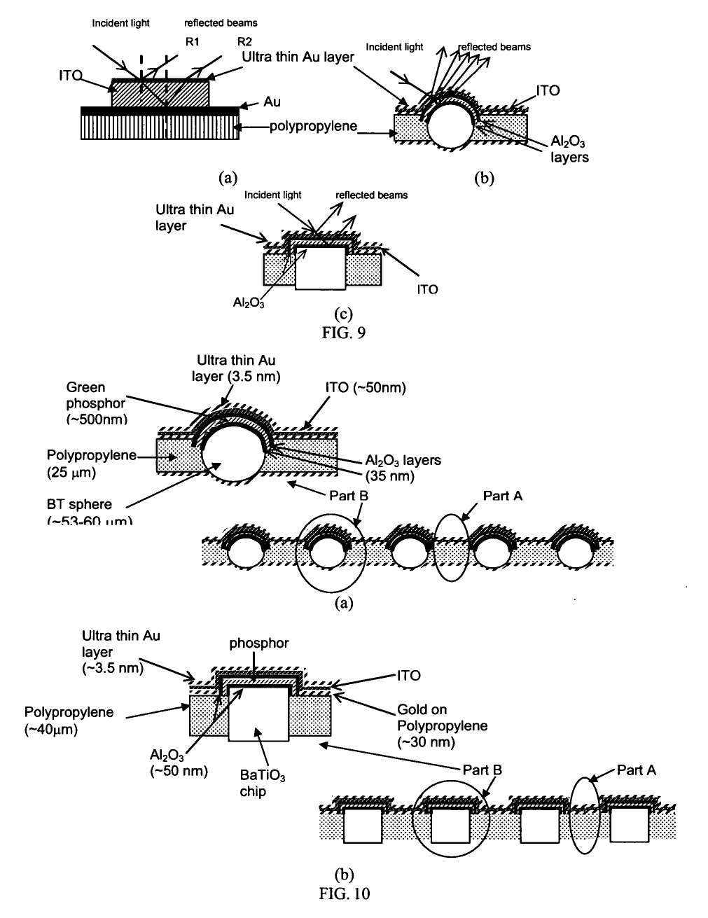

Another gold layer with a thickness of 60 nm is sputtered on the rear side of the device as the rear electrode of the device as shown in FIG. 1. However, the adhesion between this gold layer and the polypropylene sheet is not good. A sandwich structure of the electrode composed of ITO layers and sandwiched gold ultra-thin layers was developed to improve the adhesion between the electrode and the polypropylene sheet; however, it has been found that the low adhesion is due to a surface treatment on the polypropylene used. Further tests on untreated polypropylene show increased adhesion as well as enhanced contrast due to the antireflection layer.

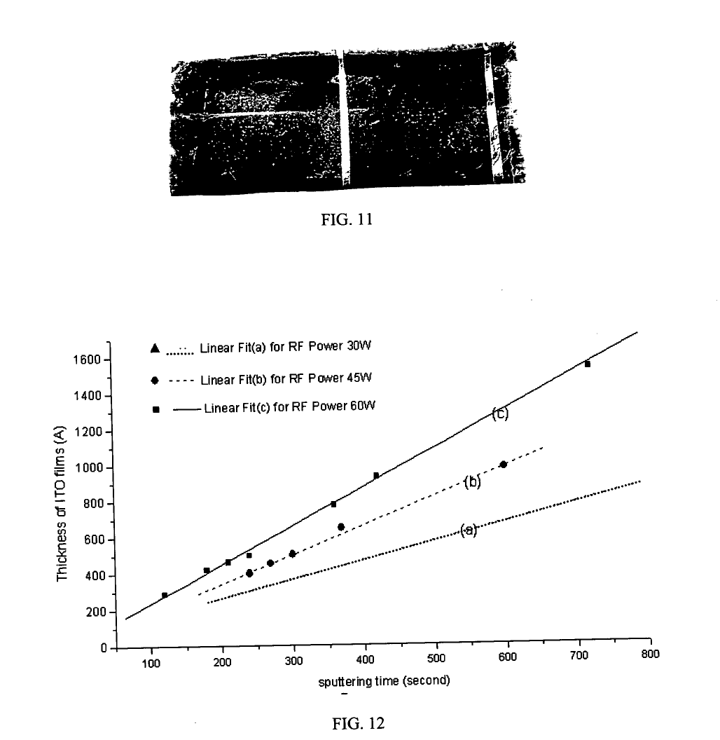

Based on the optimization of sintering temperature of BaTiO₃ spheres and AR coating technology, an SSTFEL display device with high efficiency of about 1.48 Lm/W was fabricated and is shown in FIG. 11. Two vertical bright strips on the device surface do not have AR coatings. The 3.5 nm gold layer was not deposited in these areas, and the reflectance in these strips is very high. Areas of low reflectance show as dark areas in the figure; 3.5 nm ultra-thin gold has been deposited in the dark areas to form AR coating. It can be seen that AR coatings obviously reduce the reflection of ambient light from the surface of the EL device.

TABLE 2
SPUTTERING CONDITIONS OF ITO FILM

| Sputtering Parameters | Value |
|---|---|
| Chamber pressure (mTorr) | 0.5 |
| RF Power(W) | 30 |
| Ar Flow (sccm) | 7.0 |
| Substrate Temperature | Room temperature |

### Experiment I

### Discussion:

### Deposition and Characterizations of the ITO and Ultra-Thin Gold Films

An ITO layer and an ultra-thin gold layer deposited on the surface of the SSTFEL device not only works as a transparent and conductive electrode but also as component layers of an AR coating in this invention. The thickness of the ultra-thin gold layer and the ITO layer should be optimized to reduce the reflectance of the ambient light from the surface of SSTFEL devices. As reported in the literature, optical and electric properties of ITO films are particularly sensitive to the deposition conditions. Refractive index, transmittance and sheet resistance of the ITO films with thickness ranging from 30 to 60 nm have been measured and reported here. The optical and electric properties of the ultra-thin gold films have been studied also. AFM technology was used to explore the surface morphology of ultra-thin gold layer on Si substrates and on polypropylene sheets. Experimental results show that the ultra-thin gold film has unexpected electric properties when its thickness is around 3 nm.

### ITO Optical and Electrical Characteristics

Because the chamber pressure and RF power directly affect the index, and the transparence and sheet resistance of the ITO layer, it is necessary to optimize the sputtering conditions for lower sheet resistance and higher transparence of the ITO layer. On the other hand, controlling the thickness of the ITO layer is also very important as it is a layer in AR coatings. Therefore, ITO layers were deposited on Si substrates in order to measure their index and thickness with PZ2000 ellipsometry. ITO films were deposited on the surface of Si substrates that had been etched for 40 seconds in an HF and H₂O mixed solution of 1:40 (wt %) to remove a naturalized SiO₂ film on the surface of Si substrates.

### Thickness of ITO Films Relevant to Deposition Conditions

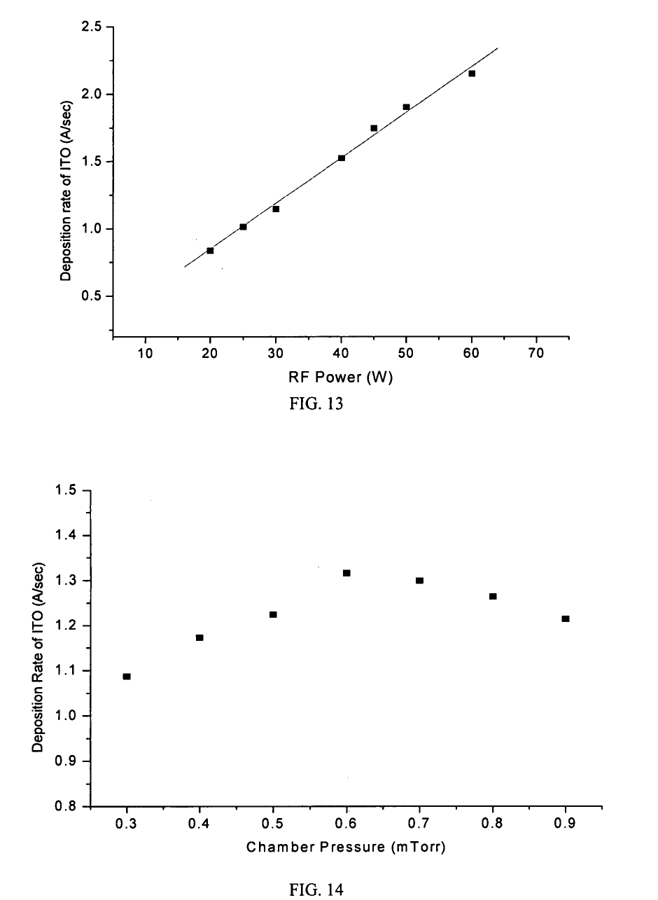

Several groups of ITO layers sputtered on Si substrates were measured, and FIG. 12 shows their thickness related to sputtering times under deposition conditions with the same chamber pressure of 0.5 mTorr, the same Ar flow ratio of 7.0 sccm, but different RF powers of 30 W (a), 45 W (b) and 60 W (c). Whether the RF power is 30 W, 45 W or 60 W, the thickness of the ITO layer always linearly increases with an increment of sputtering time. The higher the RF power, the faster the deposition rate of the ITO film. The deposition ratios are (1.03±0.05) Å/sec for 30 W, (1.60±0.04) Å/sec for 45 W and (2.12±0.08) Å/sec for 60 W, respectively. The deposition rate of ITO films relevant to RF power is shown in FIG. 13. It increases linearly from (0.85±0.05) Å/sec to (2.20±0.08) Å/sec as RF power increases from 20 W to 60 W while other deposition conditions are kept unchanged.

FIG. 14 shows the deposition rate of ITO films relevant to the chamber pressure. It can be seen that the deposition rate of ITO films increases up to about 1.32 Å/sec as the chamber pressure increases from 0.3 mTorr to 0.6 mTorr, then decreases as the chamber pressure increases over 0.8 mTorr.

At the lower chamber pressure, the density of ionized Ar⁺ located near the surface of the ITO target is less than that in higher chamber pressure, which results in fewer atoms being bombed out of the ITO target and landing on the surface of the substrate. Thus the deposition rate of ITO films on the substrate is lower at the lower chamber pressure. Under the high chamber pressure, the density of ionized Ar⁺ is much higher and results in more atoms being bombed out of the ITO target. Thus, there are more target atoms collected on the surface of resulting in an increase in the deposition rate.

However, as high chamber pressure increases, some of the target atoms are diffused away by the ionized Ar⁺ with higher density near the surface of the target and cannot reach the surface of the substrate; this causes the deposition rate of ITO films to decrease as the chamber pressure increases from 0.8 to 0.9 mTorr as shown in FIG. 14.

### Electric Properties of ITO Films Relevant to Deposition Conditions

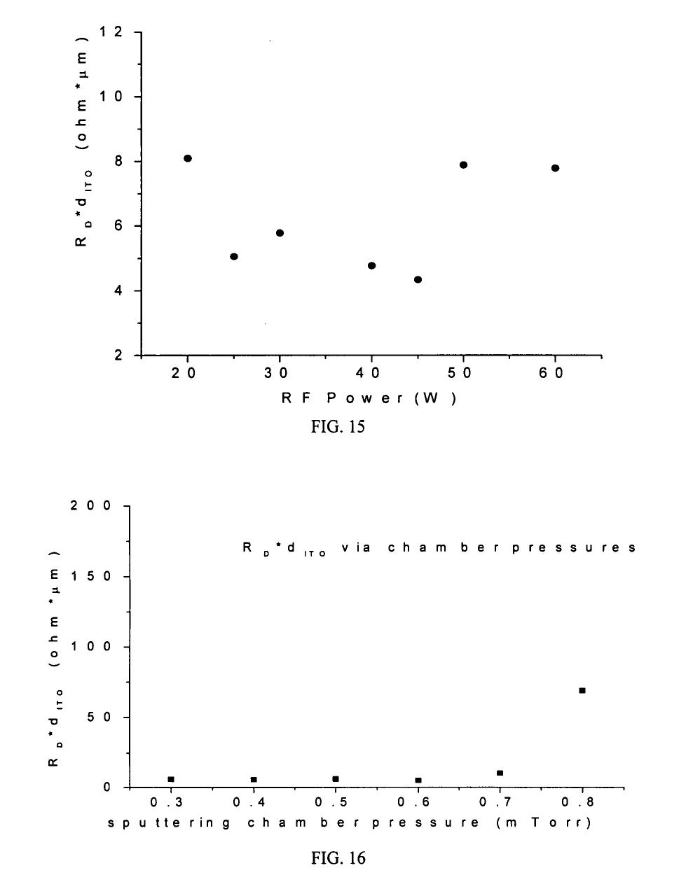

The sheet resistance of ITO films decreases as the thickness of ITO films increases while the sputtering conditions remain unchanged. The measurement results of ITO sheet resistance versus different RF powers and chamber pressures are shown in FIGS. 15 and 16. R_{□} and d_{ITO} are the sheet resistance and the thickness of ITO films, respectively. Because R_{□} is a parameter related to the ITO thickness, a parameter R_{□}*d_{ITO} is introduced as a unit of the vertical axis for comparison of the conductive property of ITO films, and, therefore, R_{□}*d_{ITO} can been seen as resistivity of ITO films. It can be seen that the resistivity of ITO films have a lower value in the region of RF power 25-45 W, while the resistivity of ITO films are higher when the RF power is lower than 25 W and higher than 50 W to 60 W.

The resistivity of ITO films shown in FIG. 16 almost keeps a constant value for the chamber pressure from 0.3 mTorr to 0.6 mTorr. Then, its value increases as the chamber pressure increases and rises quickly as the chamber pressure is increases over 0.7 mTorr.

### Refractive Index of ITO Films Relevant to Deposition Conditions

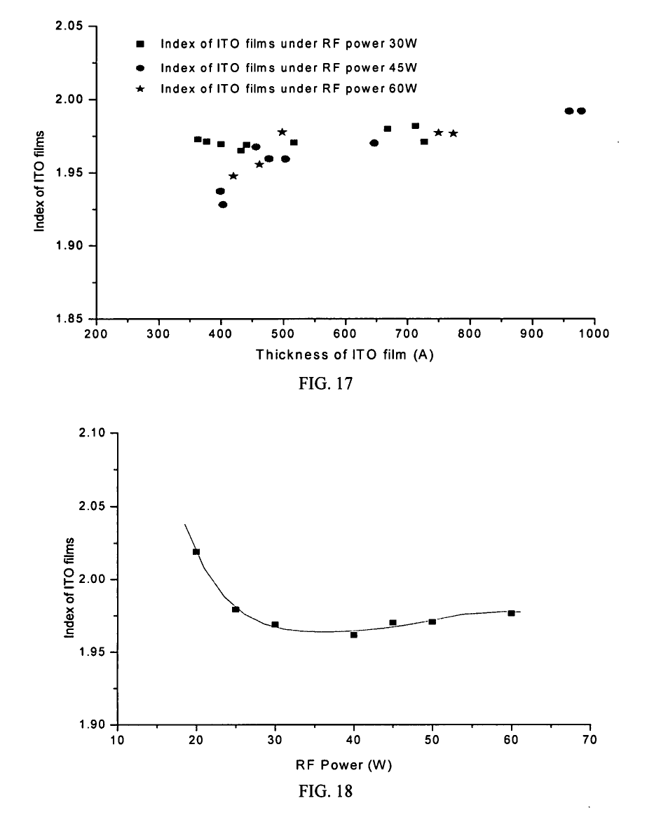

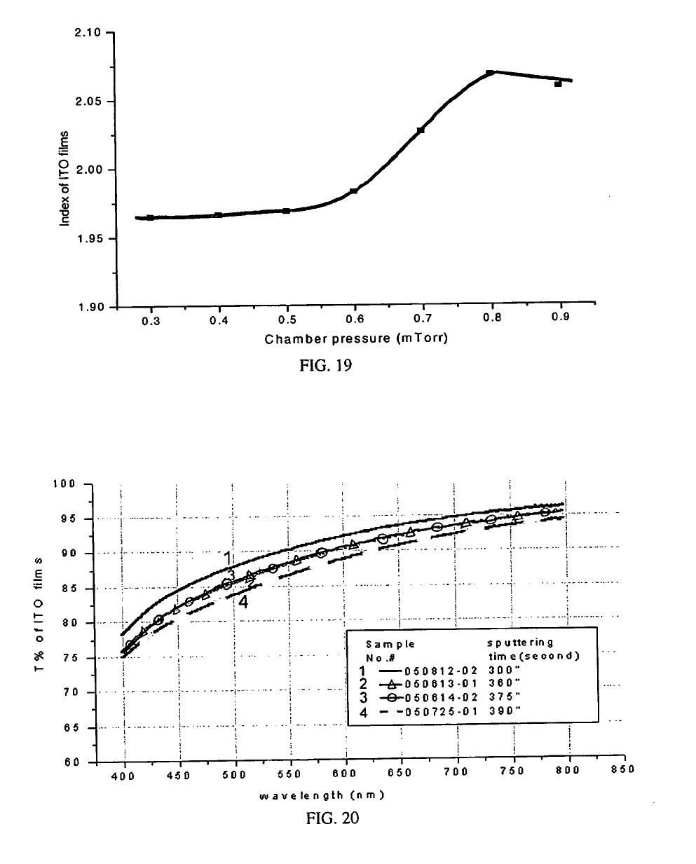

The refractive index and transmittance of an ITO film are important parameters for the design of AR coatings, and conductive and transparent electrode layers. FIG. 17, FIG. 18 and FIG. 19 show the refractive index of ITO films versus deposition conditions of the sputtering time, RF power and the chamber pressure. It can be seen in FIG. 17 that the index of ITO films is not constant for the thickness of ITO films from 300 Å to 1000 Å whether the RF power is 30 W, 45 W or 60 W. For the RF power of 45 W and 60 W, the change of ITO index is large in the thickness range of ITO films less than 500 Å. The index of the ITO film increases as thickness increases, then goes toward a constant value when the thickness of ITO films is over 500 or 600 Å. For the RF power of 30 W, the index difference of ITO films is not larger than 0.03 as the thickness of ITO films varies in the region from 300 Å to 700 Å. Therefore, it reasonably can be decided that the index of ITO films may be approximated by an average value of 1.97 under the deposition conditions with the chamber pressure of 0.5 mTorr and RF power of 30 W.

Data in FIG. 18 shows the relationships between the index of ITO films and RF power under deposition conditions with the chamber pressure of 0.5 mTorr and sputtering time of 360 seconds. The index of ITO films decreases quickly as the RF power increases from 20 W to 30 W, then increases slowly as the RF power increases from 30 W to 60 W.

By maintaining RF power at 30 W and changing the chamber pressure, as can be seen in FIG. 19, the index of ITO films almost remains constant in the region of the chamber pressure from 0.3 mTorr to 0.5 mTorr, and increases as the chamber pressure increases from 0.6 mTorr to 0.8 mTorr.

### Transmittance of ITO Films Relevant to Deposition Conditions

The transmittance spectra of ITO films were measured by Cary 50 Probe UV-Visible Spectrophotometer. ITO films were deposited on glass slide substrates under different sputtering conditions. As shown in FIG. 20, the transmittances of ITO film decrease as the deposition time increases and also as the thickness of ITO films increases. The decrease of transmittances of ITO film is shown by the whole spectral curve moving down in visible wavelength range, but the shape of curves remains the same (or “constant”). The transmittance is larger than 75% in the region from 400 nm to 700 nm and larger than 80% at the wavelength up to 450 nm if the sputtering time is less than 6 minutes.

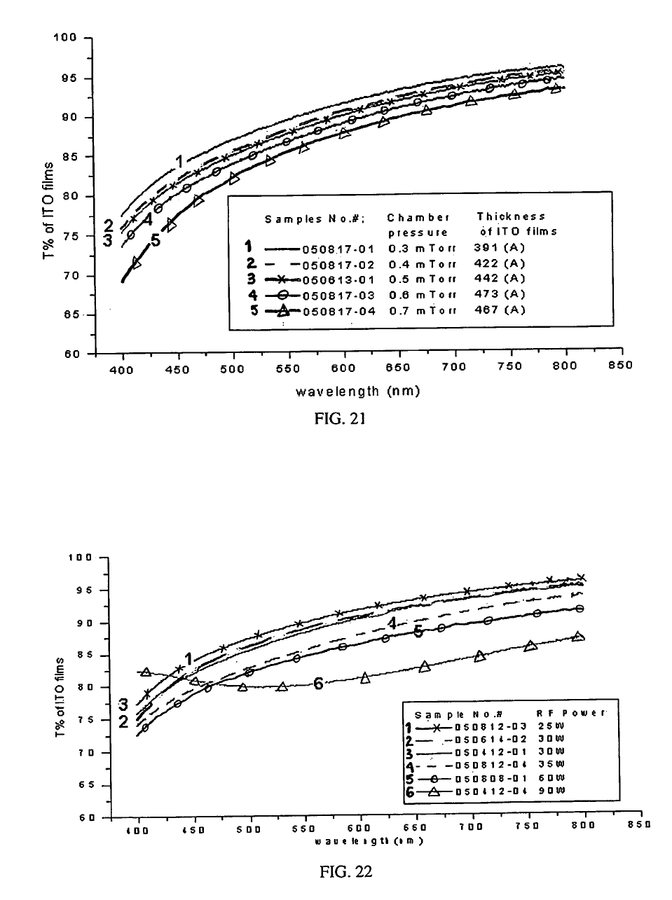

In FIG. 21, it can be seen that the transmittance of the ITO film decreases as the chamber pressure increases. However, the thickness of the ITO film also increases when the chamber pressure increases from 0.3 mTorr to 0.6 mTorr. As already known, the thicker the ITO film, the lower the ITO transmittance. The small change of ITO transmittance indicates that the chamber pressure has little effect on the transmittance of ITO films while it increases from 0.3 mTorr to 0.6 mTorr. However, the chamber pressure significantly affects the transmittance of the ITO film when it is as high as 0.7 mTorr. The transmittance of the ITO film deposited at the chamber pressure of 0.7 mTorr is smaller than that of the ITO film deposited at the chamber pressure of 0.6 mTorr, but the thickness of the ITO film deposited at the chamber pressure of 0.7 mTorr is less than thickness of the ITO film deposited at the chamber pressure of 0.6 mTorr as shown in FIG. 21.

Similarly, the RF power affects the transmittance of ITO films when ITO films were deposited under the higher RF power. At RF power of 90 W, the transmittance spectrum of the ITO film, shown in FIG. 22, is different from other transmittance spectra obtained at lower RF powers. Not only does the shape of this spectrum curve change, but it is also much lower than that deposited at lower RF powers in the wavelength ranging from 500 nm to 700 nm, although, it is higher at the short wavelength region below 450 nm.

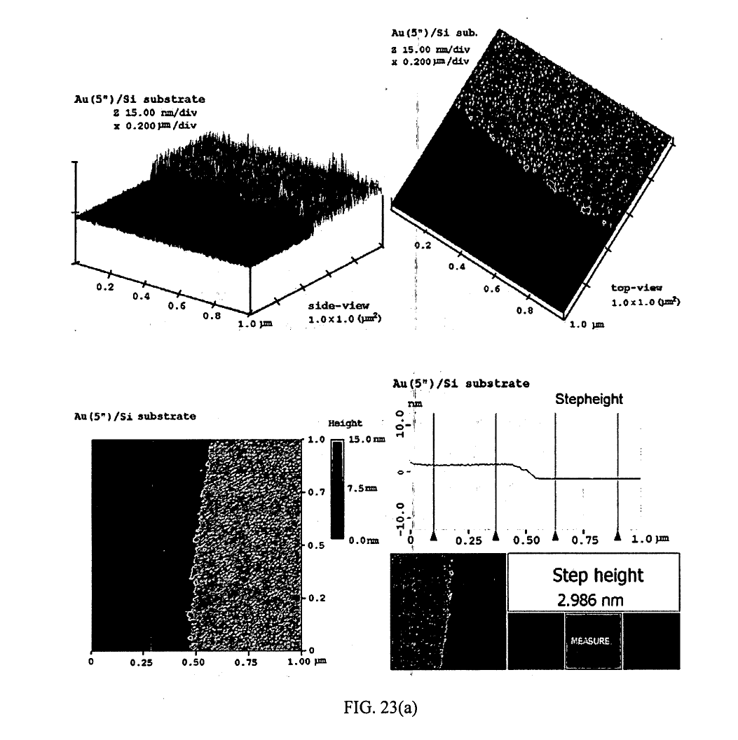

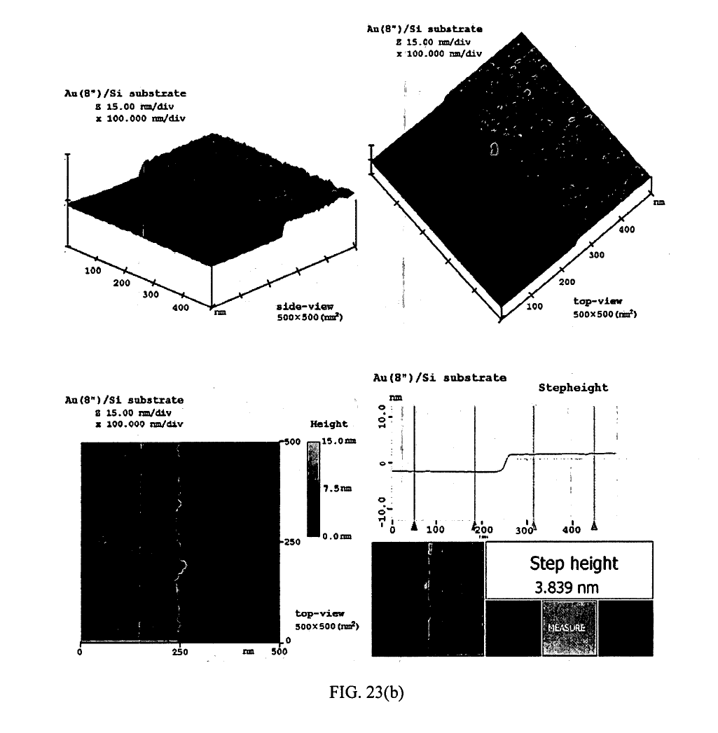

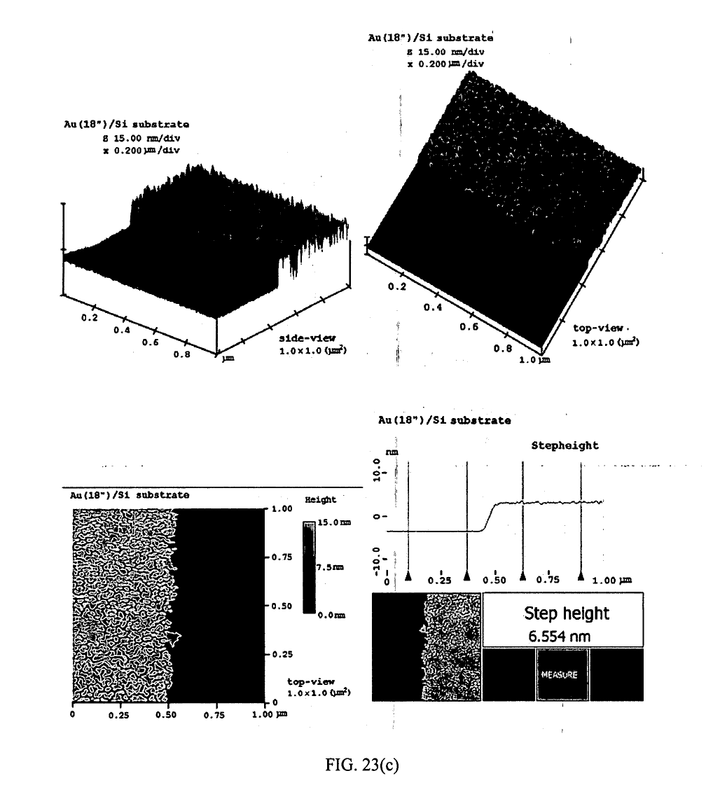

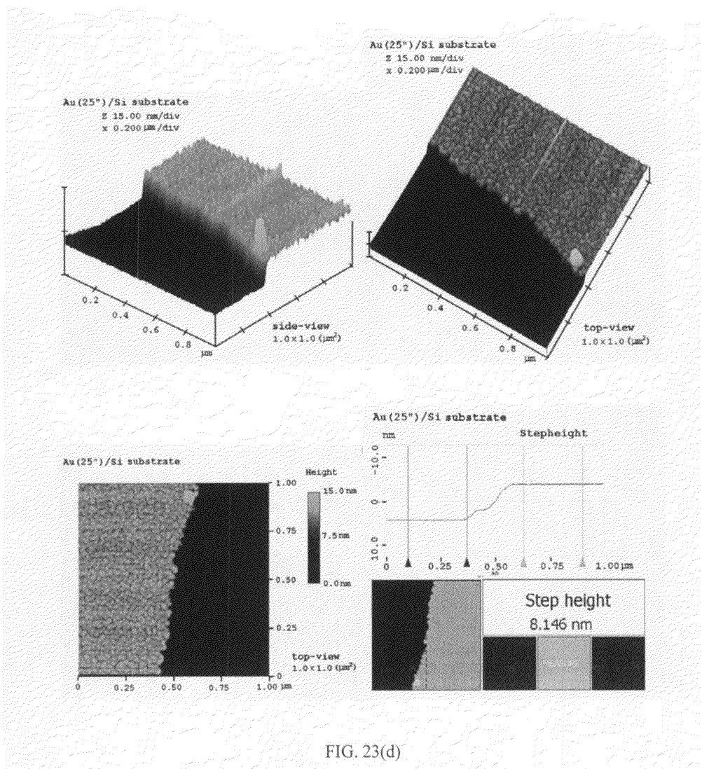

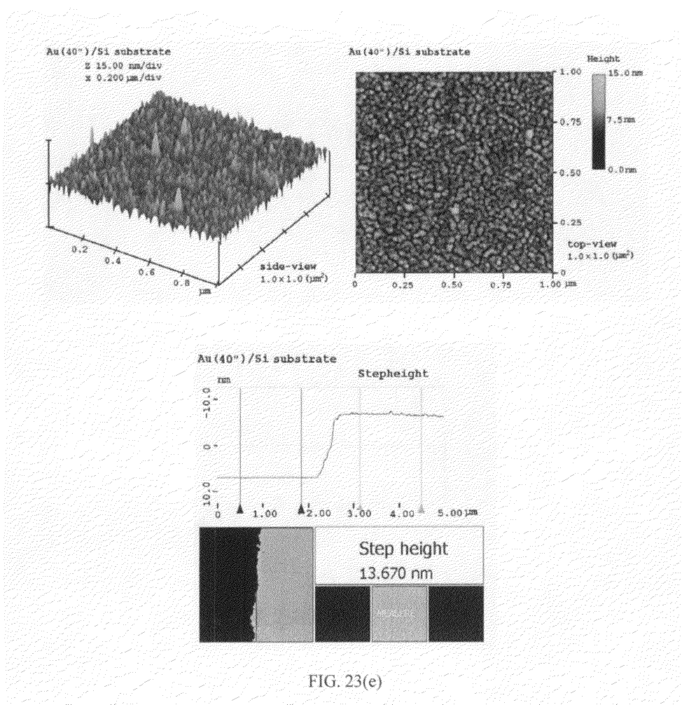

Other transmittance spectra of ITO films are similar to the shape of the spectrum curve while RF power is lower than 60 W. Two curves obtained at the same RF power of 30 W are very close, which indicates that the repeatability of the sputtering process is very good for ITO transmittance. On the other hand, transmittance of an ITO film deposited under RF power of 30 W is higher than that of an ITO film deposited at RF power of 35 W, although the differences of deposition rate between them are small, as shown in FIG. 23.

Finally, considering electric and optical properties and relevant deposition conditions, the deposition conditions with RF power of 30 W, the chamber pressure of 0.5 mTorr and Ar flow ratio of 0.7 sccm are best to sputter ITO films as a conductive and transparent film for SSTFEL devices. ITO film deposited for 6 minutes under such conditions has transmittance larger than 75% at short wavelength 400 nm and over 80% at the wavelength ranging from 450 nm to 800 nm, high conductivity and lower sheet resistance of 131.2±6.1Ω/□ (Ohms per square) and the index of about 1.97 at a thickness of (425±29) Å.

### Characteristics of Ultra-Thin Gold Film

Various growth techniques and morphology of an ultra-thin metal layer including gold, silver, copper and aluminum have been reported in the literature. They were utilized in the fabrication of filters, AR coatings and gas sensors. In the present invention, ultra-thin gold layers were sputtered on the substrates at room temperature by using an S150B Sputter Coater. All sputtering conditions except sputtering time were kept unchanged for all samples. The chamber pressure was kept at 0.18 Torr with Argon atmosphere, sputtering current of 20 mA and voltage of 1.2 kV. AFM was used to measure the thickness of ultra-thin gold films and explore their morphology.

### Surface Morphology of Ultra-Thin Gold Films

The results of AFM measurements over a scanning area of 500 nm×500 nm and 1 μm×1 μm on ultra-thin gold films deposited on the Si substrate are shown in this section. Before sputtering, Si substrates were cleaned and then treated in HF:H₂O mixed solution with 1:40 (wt %) for 40 seconds to remove a naturalized SiO₂ film on the surface of Si substrates.

There are five groups of images in FIG. 23, which represent a series of ultra-thin gold films deposited ranging from 5 seconds (5″) to 40 seconds (40″). In each group, there are three AFM images viewed from different angles. The fourth image is the thickness measurement of this ultra-thin gold film. The step in the fourth image was scratched for the thickness measurement by moving a pointed end of a tweezers on the surface of the ultra-thin gold film.

In FIG. 23(a), with sputtering time of 5 seconds, the thickness of the ultra-thin gold film is 2.98±0.15 nm. It can be seen that the ultra-thin gold film is composed of tiny islands distributed densely and separately on the surface of the Si substrate, which agrees with the literature. As the sputtering time increases to 8 seconds, the thickness of the ultra-thin film is 3.84±0.19 nm, and the tiny gold islands become bigger and contact each other as shown in FIG. 23(b). These islands are still clearly distinguishable when the sputtering time is increased to 18 seconds, resulting in a thickness of ultra-thin gold film of about 6.55±0.33 nm; several tiny islands connect with each other to form an island chain as shown in FIG. 23(c). The morphology of the ultra-thin gold film obviously shows that the film is composed of island chains forming separate regions, not islands. The separate regions disappear in FIG. 23(d) when the sputtering time is increased to 25 seconds, and the island chains grow bigger. However, the boundary among island chains can still be identified. Therefore, the gold film is not a continuous film. In FIG. 23(e), it is obviously seen that there are many bright points on the surface of gold island chains from the top-view of AFM image. They are new tiny isolated islands forming on the top of island chains, which can be also seen in previous reports. It is similar to existing growth models such as the Volmer-Weber model. It could be assumed that a new layer begins to form over the island chains before these islands chains form a continuous film, and this type of layer, which is composed of numerous island chains, stacks one by one to form a continuous film in the macroscopic structure.

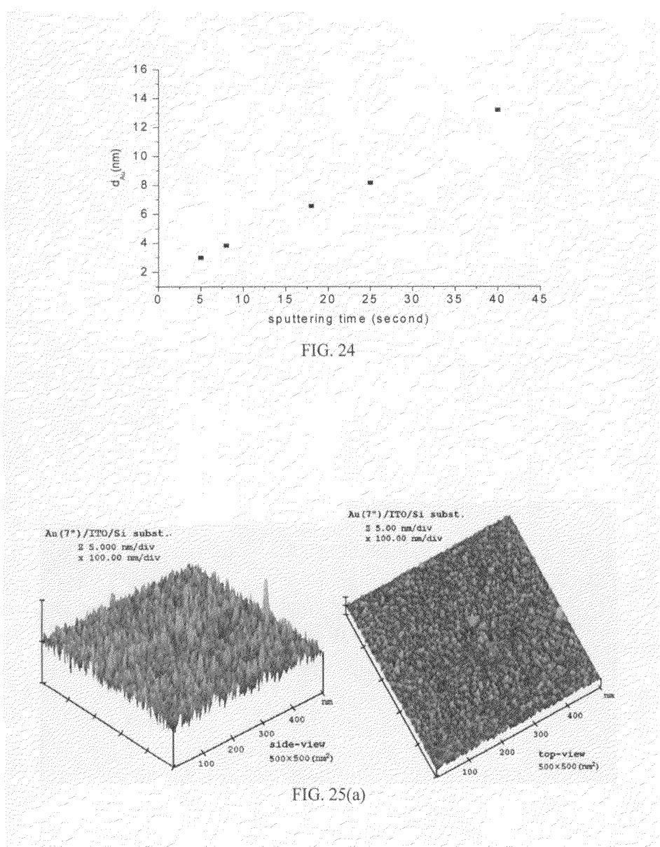

The thickness of ultra-thin gold films versus the sputtering times is shown in FIG. 24. It is linear as expected, and the sputtering rate is 0.29±0.01 (nm/sec).

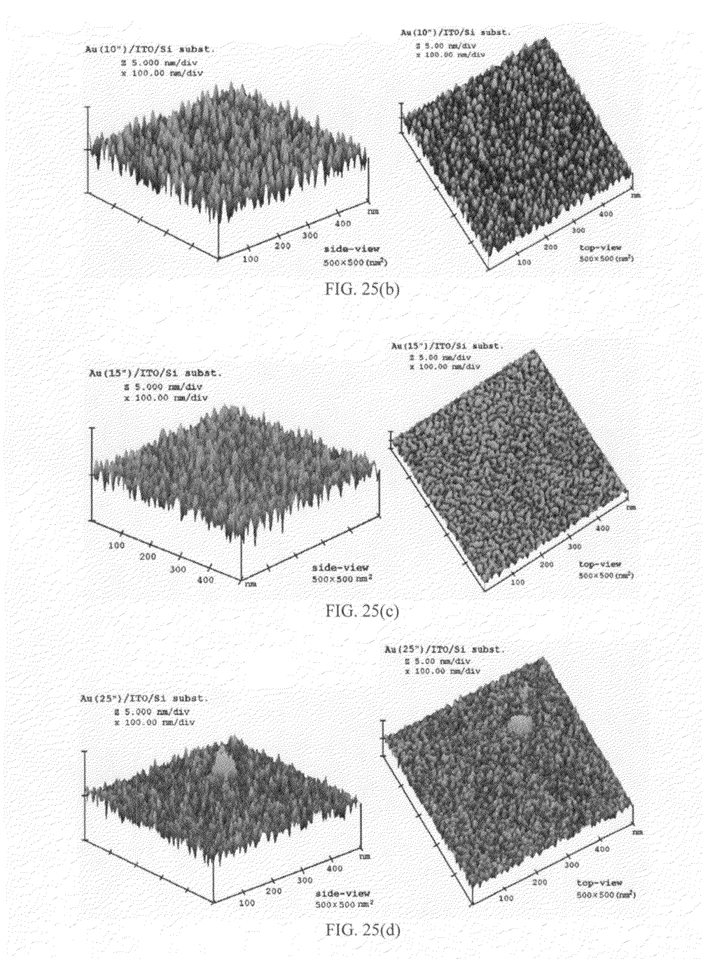

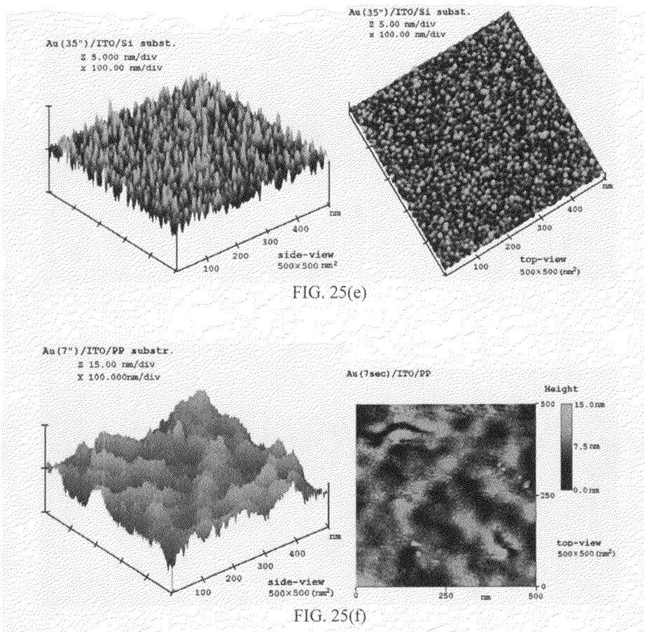

The morphology of ultra-thin gold films deposited on the surface of ITO/Si substrates and ITO/polypropylene sheets was scanned by AFM over an area of 500 nm×500 nm, which are shown in FIG. 25. Although the surface of the ITO layer shown in FIG. 25(a) is not as smooth as the surface of Si substrates, shown in the dark color area in side-view images of FIG. 23, the morphology of the ultra-thin gold film on the surface of ITO layers is still similar to that of the ultra-thin gold film sputtered on the Si substrates. As the sputtering time increases from 7 seconds to 35 seconds, the ultra-thin gold film at first is composed of tiny isolated gold islands distributed densely on the surface of ITO layers shown in FIG. 25(a), and these islands become bigger in FIG. 25(b) as the sputtering time reaches 10 seconds; then the islands connect together to form island chains when sputtering time increases to 15 seconds, shown in FIG. 25(c). Because dimensions of X, Y and Z axes in FIG. 25 (500 nm×500 nm in X and Y axis and 5 nm in Z axis) are different from that in FIG. 23 (1 μm×1 μm in X and Y axis and 15 nm in Z axis), the morphology of ultra-thin gold films in FIG. 25 looks different from that in FIG. 23. However, bright points on the surface of gold islands are also seen in FIG. 23(e). It can be assumed that the formation of a continuous thick gold film involves stacking by layers, which are composed of island chains.

When an ultra-thin gold film is sputtered on the surface of ITO films on the polypropylene sheet, its morphology is similar to that on Si substrates or on ITO/Si substrates. After annealing at 200° C., the smooth surface of the polypropylene sheet becomes wavelike. The wavelike morphology does not change when an ITO film is sputtered on its surface at room temperature. After an ultra-thin gold layer is sputtered on the top of the ITO layer for 7 seconds, tiny gold islands distribute on this wavelike surface as on the surface of Si substrates, which is shown in FIG. 25(f). The morphology of the ultra-thin gold layer does not change.

### Electric Properties of Ultra-Thin Gold Films

In the structure of SSTFEL and Nixel devices, the top electrode is composed of three layers on the surface of polypropylene sheets as shown in FIG. 10. The three layers are a thick gold layer (30 nm), an ITO layer and an ultra-thin gold layer. In part A of the device surface, shown in FIG. 10, the conductivity is mainly determined by the thickness of the gold film. Its sheet resistance is much lower than the sheet resistance of the ITO layer and the ultra-thin gold layer. However, on the top of BaTiO₃ spheres/chips, as shown in FIG. 10 as the part B region, the electrode is only composed of two layers, which are the ITO layer and the ultra-thin gold layer. Measured results show that these two layers contribute to the conductivity of this electrode.

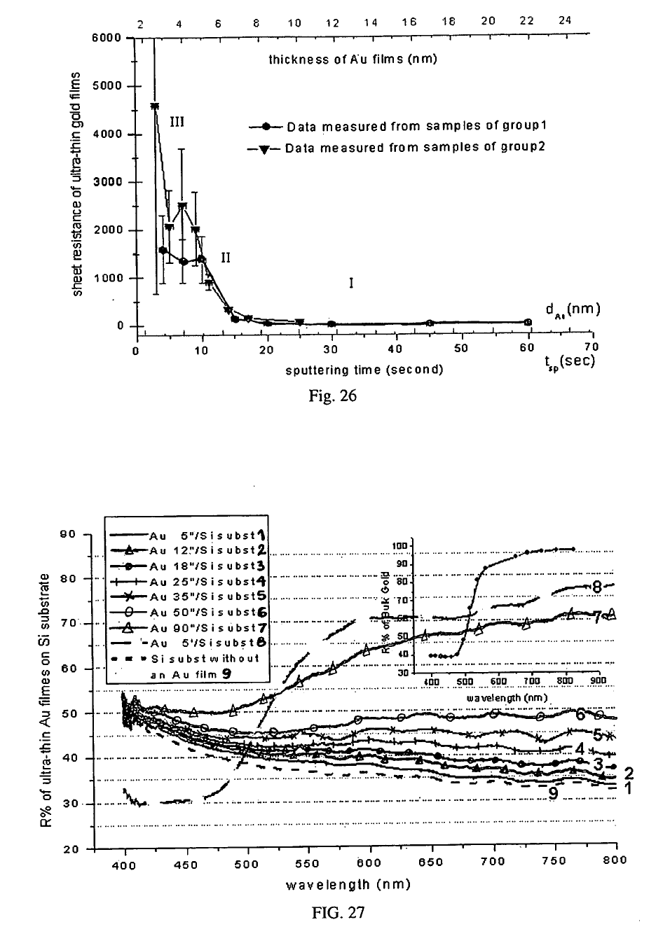

Tables 3 and 4 are the results of the sheet resistance measured with a 4-point probe on two group samples. In these samples, ITO films were first deposited on glass substrates under sputtering conditions of RF power of 30 W, chamber pressure of 0.5 mTorr and sputtering time of 6 minutes; then ultra-thin gold films were sputtered from 3 seconds to 60 seconds on the top of ITO films. Before sputtering ultra-thin gold films, the sheet resistances of ITO films on each glass substrate were measured. The total sheet resistances of the two layers were measured quickly after ultra-thin gold films were sputtered because the ultra-thin gold film is very active in atmosphere. As shown in FIG. 26 and Table 3, data of the first group indicates that the conductance of the ultra-thin gold layer dominates the conductance of the composite AR coatings when the sputtering time of the ultra-thin gold layer is more than 20 seconds. However, the ultra-thin gold layer almost does not contribute to the conductance of the composite AR coatings if the sputtering time of the ultra-thin gold layer is less than 10 seconds.

For the sputtering time of more than 20 seconds, as well as the stage I region, sheet resistance of ultra-thin gold films are 34.2±1.2Ω/□ for 20 seconds, 14.3±0.4Ω/□ for 30 seconds and 7.2±0.2Ω/□ for 60 seconds. The sheet resistance of the ultra-thin gold film is inversely related to the sputtering time, as well as thickness, for the thickness of ultra-thin gold films is linear with the sputtering time as shown in FIG. 23. The sheet resistance of the ultra-thin gold film abides by the ohmic law and the formula of R_{□}=ρ/d_{Au} provided that the thickness of ultra-thin gold layer is more than 6.55±0.33 nm or sputtering time of 18 seconds. When the thickness of ultra-thin gold films is larger than 6.55±0.33 nm, ultra-thin gold films are composed of long island chains as shown in FIG. 23(c), (d) and (e), which results in ultra-thin gold films having the electric properties of continuous films.

TABLE 3*
the voltages measured with 4-point probe and relevant
calculated resistance (ohms/□) of samples of group

| Sample # | time | V(average)(mV) | R_{□}(Ω/□) | R_{Au□}(Ω/□) |
|---|---|---|---|---|
| 050825-1 | ITO 6′ 30″ | 233.3 ± 5.7 | 105.7 ± 3.0 | |
| | Au 4″ | 218.7 ± 5.1 | 99.1 ± 2.7 | 1590.4 ± 698.8 |
| 050825-2 | ITO 6′ 30″ | 256.1 ± 6.7 | 116.0 ± 3.4 | |
| | Au 7″ | 235.6 ± 6.2 | 106.7 ± 3.2 | 1335.7 ± 458.7 |
| 050825-3 | ITO 6′ 30″ | 254.4 ± 6.2 | 115.2 ± 3.2 | |
| | Au 10″ | 234.6 ± 6.5 | 106.3 ± 3.3 | 1367.6 ± 482.3 |
| 050825-4 | ITO 6′ 30″ | 246.9 ± 5.9 | 111.8 ± 3.1 | |
| | Au 15″ | 132.5 ± 4.0 | 60.0 ± 2.0 | 129.6 ± 6.6 |
| 050825-5 | ITO 6′ 30″ | 258.6 ± 6.8 | 117.1 ± 3.5 | |
| | Au 20″ | 58.4 ± 1.5 | 26.3 ± 0.8 | 34.2 ± 0.9 |
| 050825-6 | ITO 6′ 30″ | 244.5 ± 5.6 | 110.8 ± 3.0 | |
| | Au 30″ | 27.9 ± 1.1 | 12.7 ± 0.5 | 14.3 ± 0.4 |
| 050825-7 | ITO 6′ 30″ | 256.6 ± 6.4 | 116.2 ± 3.3 | |
| | Au 45″ | 18.0 ± 0.9 | 8.2 ± 0.4 | 8.8 ± 0.3 |
| 050825-8 | ITO 6′ 30″ | 260.0 ± 7.2 | 117.8 ± 3.7 | |
| | Au 60″ | 15.1 ± 0.8 | 6.8 ± 0.4 | 7.3 ± 0.2 |

*Voltages of samples are measured by a 4-point probe measurement system at the current of 10.00 mA. Every sample was measured twice when ITO on a glass slide and an ultra-thin gold layer on ITO/Glass and displayed in two rows respectively. R_{Au□} is equivalent sheet resistance of the ultra-thin gold layer.

TABLE 4*
Sample voltages measured by 4-point probe and relevant
calculated resistance (ohms/□) for group 2.

| Sample # | Sputtering time | V(average) | R_{□}(Ω/□) | R_{Au□}(Ω/□) |
|---|---|---|---|---|
| 051110-1 | ITO 6′ (V) | 0.326 ± 0.008 | 147.6± | |
| | Au 3″ (mV) | 315.6 ± 4.0 | 143.0± | 4585.1± |
| 051110-2 | ITO 6′(V) | 0.330 ± 0.006 | 149.3± | |
| | Au 5″ (mV) | 307.4 ± 3.5 | 139.3± | 2075.1± |
| 051110-3 | ITO 6′(V) | 0.324 ± 0.007 | 146.6± | |
| | Au 7″ (mV) | 305.7 ± 4.3 | 138.5± | 2509.4± |
| 051110-4 | ITO 6′(V) | 0.321 ± 0.007 | 145.6± | |
| | Au 9″ (mV) | 299.7 ± 4.1 | 135.8± | 2012.8± |
| 051110-5 | ITO 6′ (V) | 0.310 ± 0.006 | 140.3± | |
| | Au 11″ (mV) | 268.0 ± 3.5 | 121.4± | 905.5 ± 162.3 |
| 051110-6 | ITO 6′ (V) | 0.326 ± 0.007 | 147.8± | |
| | Au 14″ (mV) | 226.6 ± 3.9 | 102.7± | 336.6 ± 26.3 |
| 051110-7 | ITO 6′ (V) | 0.350 ± 0.008 | 158.6± | |
| | Au 17″ (mV) | 170.4 ± 2.3 | 77.2 ± 1.5 | 150.5 ± 6.2 |
| 051110-8 | ITO 6′ (V) | 0.337 ± 0.006 | 152.8± | |
| | Au 25″ (mV) | 106.0 ± 2.0 | 48.0 ± 1.1 | 70.0 ± 2.2 |

*Voltages of samples are measured by a 4-point probe measurement system at the current of 10.00 mA. Every sample was measured twice when ITO on a glass slide and au ultra-thin gold layer on ITO/Glass and displayed in two rows respectively. R_{Au□} is equivalent sheet resistance of the ultra-thin gold layer.

However, when the thickness of the ultra-thin gold film is less than 6.55±0.33 nm, and sputtering time is from 7 seconds to 15 seconds, the electrical conduction mechanism is the non-ohmic conduction shown in stage II due to the discontinuity of ultra-thin gold films. Ultra-thin gold films are composed of tiny isolated islands as shown in the AFM images of FIGS. 23(a) and (b). Based on the model of the conductance by tunneling effects and the calculation by superposition of electron wave functions between islands, the conductance is a function of the temperature and distance between islands. Isolated islands diminish as the sputtering time decreases and as the thickness of ultra-thin gold films decreases; as the isolated islands diminish, the conductance exponentially decays from a carrier transfer mechanism of tunneling or thermionic emission related to the diminishing of isolated islands. Studies of ultra-thin gold films focused on non-ohmic conduction are reported only on gold films thicker than 5 nm.

In stage III, a point of inflection was observed for the first time in measurement results of two group samples. It is interesting that the conduction behavior becomes better as the thickness of ultra-thin gold films decreases from stage II. However, it is expected to be worse based on the mode of tunneling effects and thermionic emission. It is also difficult to explain this result based on the interface effects between the surface of ITO films and tiny gold islands (gold quantum dots (QDs)). It might be assumed that electron wave functions are too limited and weak by isolated gold QDs as the size of gold QDs diminishes and expand outside the space of isolated gold QDs much more. However, the space interval between isolated gold QDs does not enlarge as shown in FIG. 23(a) due to the high density of isolated gold QDs distributed on the surface of ITO films. Therefore, the superposition of electron wave functions between isolated gold QDs in this case enhances and results in tunneling effects enhancement. The conductance of the ultra-thin gold layer becomes better and results in the anomalous effect of its sheet resistance when its thickness is around 3 nm. As the thickness of the ultra-thin gold film decreases, the separation between gold QDs increases as the size of isolated gold QDs diminishes; then the superposition of electron wave functions between isolated gold QDs might be weakened. Its conductance becomes low and its sheet resistance increases quickly, as shown in FIG. 26.

### Optical Features of Ultra-Thin Gold Films

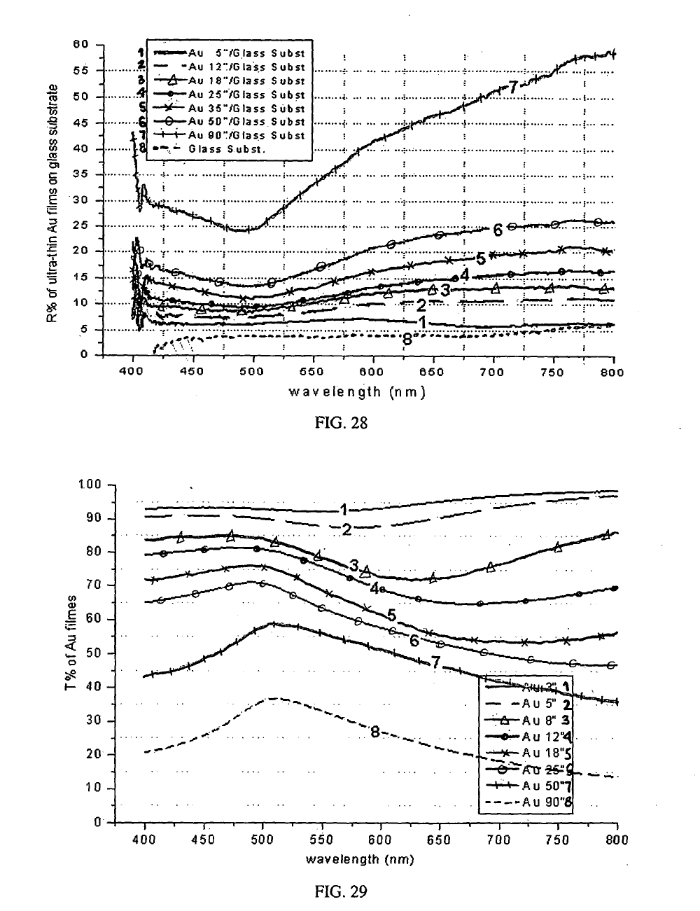

The reflection spectra of ultra-thin gold films on Si substrates and glass slide substrates were measured by SUB 2000 Fiber Spectrum of Ocean Optics Inc. The measurement results are shown in FIGS. 27 and 28. The reflection from the surfaces of the ultra-thin gold films increases with the increase of sputtering time of ultra-thin gold films and the increase of the thickness of ultra-thin gold films. As the sputtering time and ultra-thin gold film thickness increase, the reflection at the long wavelength range increases faster than that at the short wavelength range. If the gold film is sputtered for 5 minutes as shown in FIG. 27, its reflection spectrum is similar to the reflection spectrum of bulk gold with a polished surface.

However, with a sputtering time of 5 seconds, the reflection spectrum of the ultra-thin gold film is similar to the reflection spectrum of the substrate whether the substrate is Si or glass; it follows the reflection spectrum of the substrate but increasing by several percent. Therefore, by changing the thickness of the ultra-thin gold film, by adjusting its sputtering time it is possible to adjust the reflectance from its substrate. It provides a new way of looking for high refractive index materials in the design and fabrication of multi-layer AR coatings.

The transmittance spectra of ultra-thin gold films on the glass slide substrates are shown in FIG. 29, which were measured with a Cary 50 probe UV-visible spectrophotometer. To compare transmittance spectra of ultra-thin gold films on glass substrates in FIG. 27 with relevant reflection spectra in FIG. 28, it can be seen that the reflection is lower where the transmittance is higher and the reflection is higher where the transmittance is lower for ultra-thin gold films with sputtering time longer than 12 seconds. For a concave valley in the reflection spectrum, there is a convex peak in the transmittance spectrum located at the same wavelength region around 500 nm.

It is noted in the reflection spectrum of the ultra-thin gold film with sputtering time 5 seconds in FIG. 28 that its reflectance spectrum is convex at the wavelength region around 575 nm, and its transmittance shows a dent at this region of around 575 nm in FIG. 27. This phenomenon happens for the ultra-thin gold film of (2.98±0.15) nm with the sputtering time of 5 seconds. It is totally different from the reflection and transmittance spectral curves of ultra-thin gold films with the thickness greater than (2.98±0.15) nm. The sheet resistance of the ultra-thin gold film with the thickness around (2.98±0.15) nm shows an electric resistance related to this thickness of the ultra-thin gold film in FIG. 26. The image in FIG. 23(a) shows that the ultra-thin gold film with the thickness of approximately 3 nm is composed of tiny gold particles with high density.

Finally, it can be seen that the transmittance of ultra-thin gold films in the visible region is higher than 70% while the sputtering time is less than 8 seconds.

### Experiment II Discussion: AR Coating and Contrast of SSTFEL Devices AR Coatings on Polypropylene Sheets

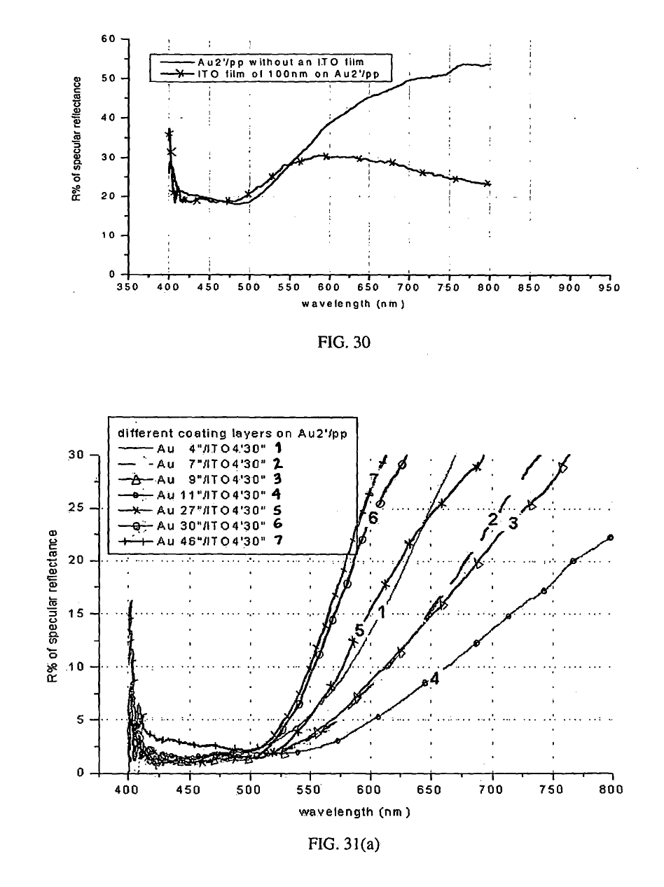

Polypropylene sheets with thickness of 0.9 mil were used in the present invention and were purchased from Copol International Ltd. A 30 nm thick gold layer was deposited on one side of the polypropylene sheet by magnetron sputtering for 2 minutes. After the two annealing processes as well as two embedding processes described above, an ITO film of 100 nm was deposited on the top of samples to simulate the part A area of the surface of SSTFEL devices shown in FIG. 10. FIG. 30 shows the specular reflectance spectra of two samples. They were measured by USB2000 Fiber Optic Spectrometer.

Reflectance, shown in the fine black line, is over 18% in the whole visible wavelength, and over 25% in green and red region of the visible wavelength, which results from high reflectance of the 30 nm gold layer on the polypropylene sheets. The bold black curve is the specular reflection spectrum of a sample without an ITO layer. It is like the reflection spectrum of bulk gold with a polished surface shown in the in-site of FIG. 30.

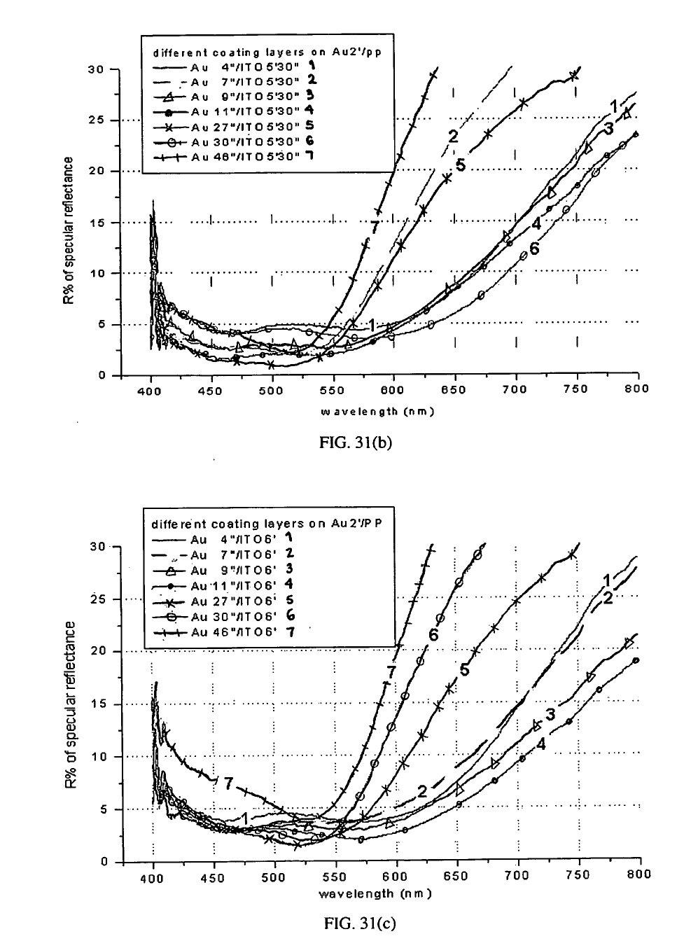

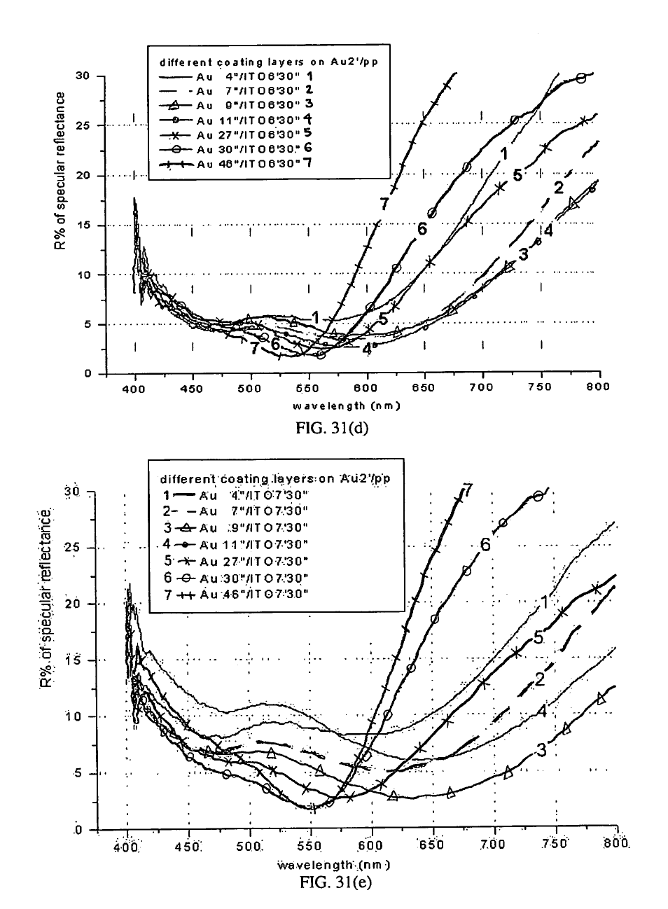

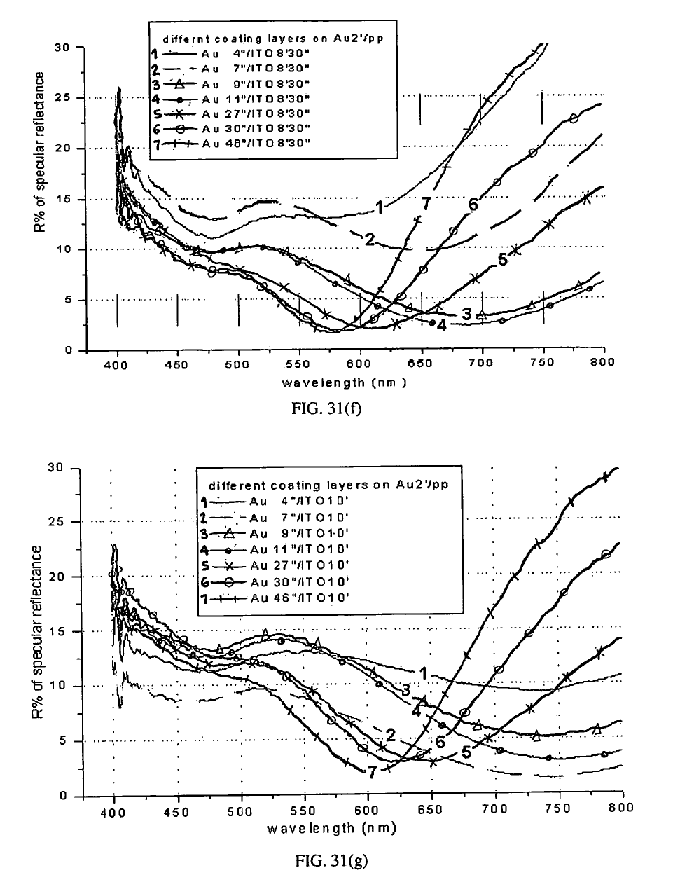

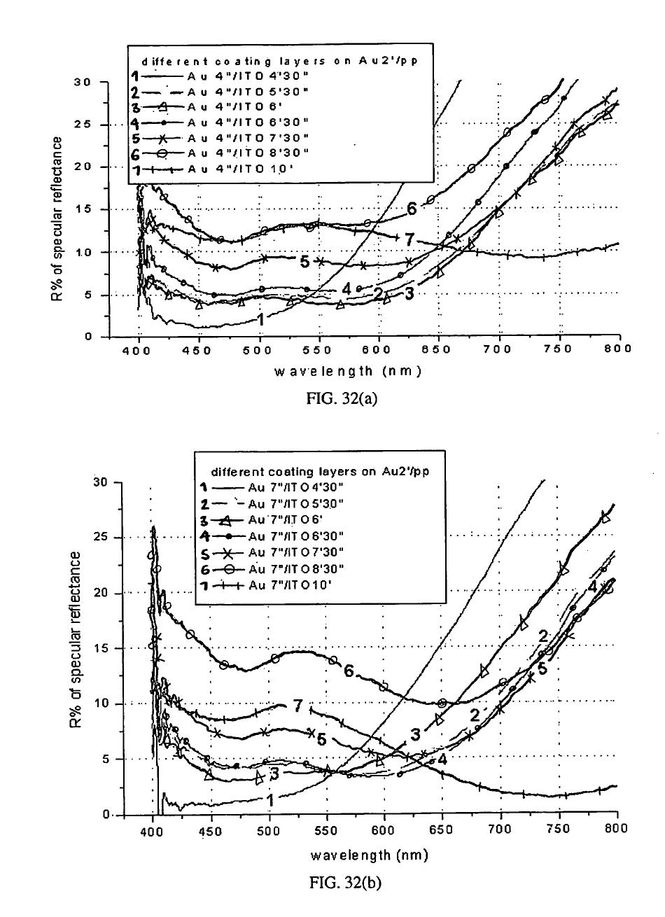

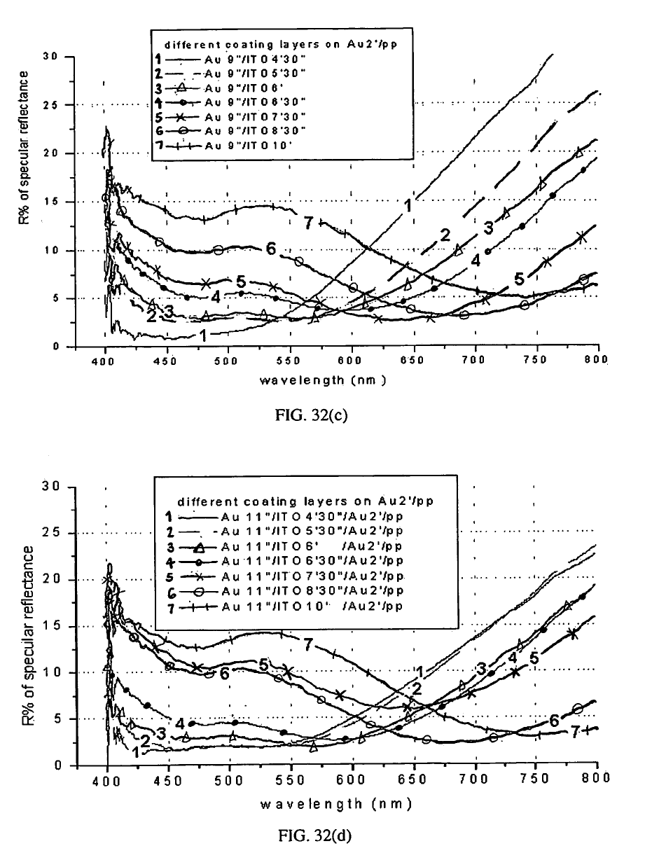

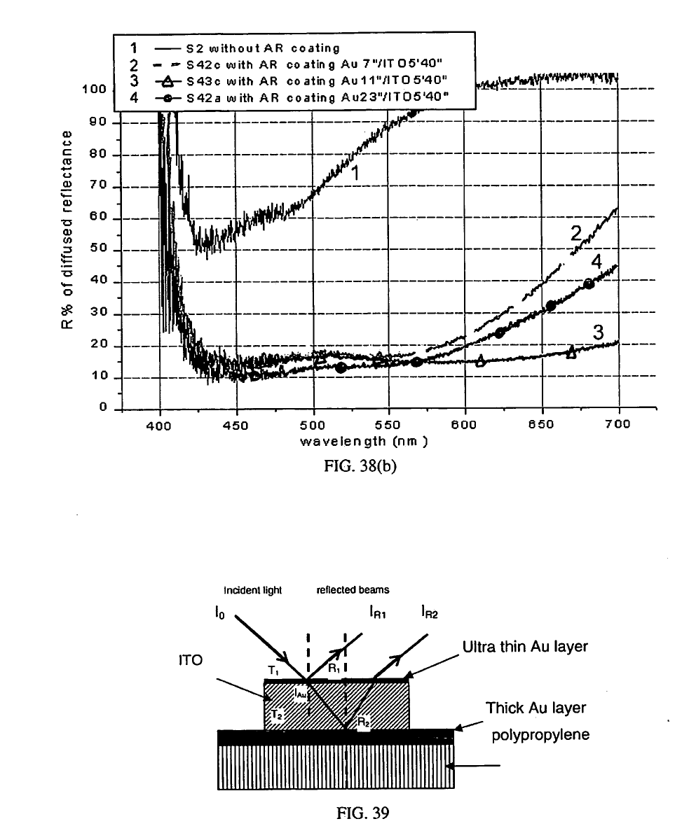

After two layers of AR coatings were sputtered on the top of polypropylene sheets with the 30 nm thick gold layer, the reflectance of samples dropped down quickly. FIG. 38 shows these measurement results of specular reflectance spectra of samples, which are organized in groups based on the sputtering time of ITO layers. Comparing spectra in FIG. 30 with that in FIG. 32(d), it can be seen that the specular reflection of samples with AR coatings obviously drops in the whole visible wavelength range when the proper thickness of AR coating layers was selected. Compared with those in FIG. 31, respectively, it can be found that the minimum reflectance moves from shorter wavelengths to longer wavelengths as the sputtering time of ITO films increases, and as thickness of ITO films increases. Because the increase of ITO thickness results in an increase in optical path length in the ITO layer, destructive interference occurs in the longer wavelength region for thicker ITO films.

In the long wavelength region in FIGS. 32(a) and (g), it also can be seen that the ultra-thin gold layer in AR coatings is an adjusting layer of lightwave amplitudes to match amplitude of both reflection beam R1 and R2 shown in FIG. 10, to allow the maximum destructive interference between R1 and R2. R1 and R2 are, respectively, the light beams reflected from the surface of the ultra-thin gold layer and the interface between the ITO layer and the bottom thicker gold layer on polypropylene sheets.

At the long wavelength region, when the ultra-thin gold layer thins as the sputtering time decreases to 4 seconds, R1 is weaker and most of the incident light passes through it with high transmittance. Although incident light was absorbed by the ITO layer and the ultra-thin gold layer, the loss is less in the case of the ultra-thin gold layer. R2 is strong due to the high reflection from the bottom thick gold layer as a bold black curve shows in FIG. 30. Therefore, two beams cannot cancel even if they are completely out of phase, which results from the difference between R1 and R2. Thus the reflection is still strong in this longer wavelength region, and it can be seen in every group of FIG. 31.

As the thickness of the ultra-thin gold layer increases, R2 decreases and R1 increases. The difference between them surges between large and small, as shown in FIG. 31(f). The reflectance spectrum of samples is high at sputtering of 4 seconds; drops at 7 seconds, and reach the minimum at 9 and 11 seconds. Then the reflectance rises further while sputtering time increase from 27 to 46 seconds.

In the short wavelength region, this phenomenon can be observed in FIG. 38(b). The reflectance spectra of samples are high for sputtering times of 4 and 7 seconds; drop at 9 seconds, and reach to minimum at 11 and 27 seconds. Then reflectance rises while sputtering time increases from 30 to 46 seconds.

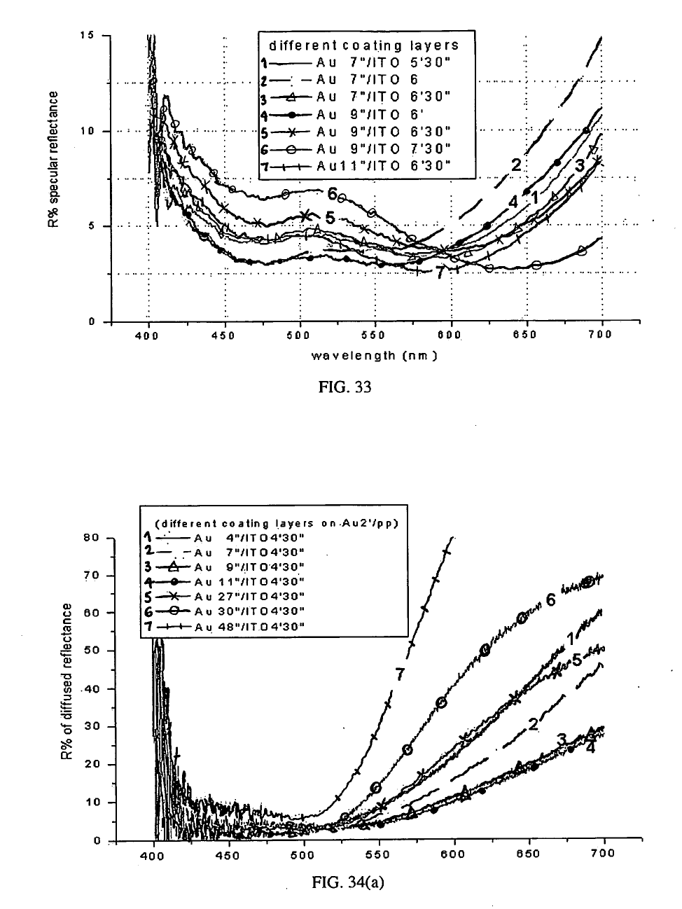

Compared with all reflection spectra in FIG. 31, it can be found that AR coatings have better performance when they are composed of ultra-thin gold layers with sputtering time ranging from 7 to 11 seconds and ITO layers ranging from 5′30″ (5 minutes and 30 seconds) growth time to 6′30″. Related thicknesses of the ultra-thin gold layer range from (3.44±0.27) nm to (4.59±0.29) nm, and thicknesses of the ITO layer range from (395±28) Å to (455±30) Å. These reflectance spectra are present in FIG. 32 based on the sputtering time of ultra-thin gold layers. Finally, the spectrum curves with low reflectance in FIG. 32 were selected and shown in FIG. 33. Areas included by these selected spectra in the visible wavelength from 410 nm to 700 nm were calculated by the integrate function in the Calculus item of Origin Software and results are present in the Table 5. The wavelength region from 400 nm to 410 nm was discarded in the calculation due to the measurement noise.

While the AR coating with constituent layers of Au 11″/ITO 6′30″ has lowest integration areas, the AR coating has best performance in reducing the specular reflectance and with high transmittance while its constituent layers are Au 7″/ITO 6′30″ and Au 9″/ITO 6′, as well as the thickness of Au (3.4±0.3) nm/ITO (455±99) Å and (4.0±0.3) nm/ITO (425±29) Å. Their specular reflectances in visible wavelength range are 4.9% and 4.7% respectively.

TABLE 5
Integration areas of specular reflection
spectra ranging from 410 to 700 nm for lower
spectra of samples in FIG. 33

| | sputtering time of | |
|---|---|---|
| | related AR coating | Integration |
| Sample # | layers | areas(nm) |
| 2-7 | Au 7″/ITO 5′30″ | 1466.87 |
| 7-7 | Au 7″/ITO 6′ | 1647.81 |
| 3-7 | Au 7″/ITO 6′30″ | 1431.54 |
| 7-2 | Au 9″/ITO 6′ | 1375.19 |
| 3-2 | Au 9″/ITO 6′30″ | 1568.10 |
| 4-2 | Au 9″/ITO 7′30″ | 1535.91 |
| 3-1 | Au 11″/ITO 6′30″ | 1308.69 |

After annealing at 200° C. for several seconds, the smooth surface of the polypropylene sheet became wavelike. Its surface morphology is shown in FIG. 25(f). Therefore, there is a small amount of diffuse reflection from the surface of samples under ambient incident light. Diffuse reflection spectra of these samples were also measured in an office by USB 2000 Fiber Spectrometer under ambient light of about 300Lux. Ambient illuminance of the laboratory was measured by Luminance Meter LS-100 of Minolta Camera Co. Ltd.

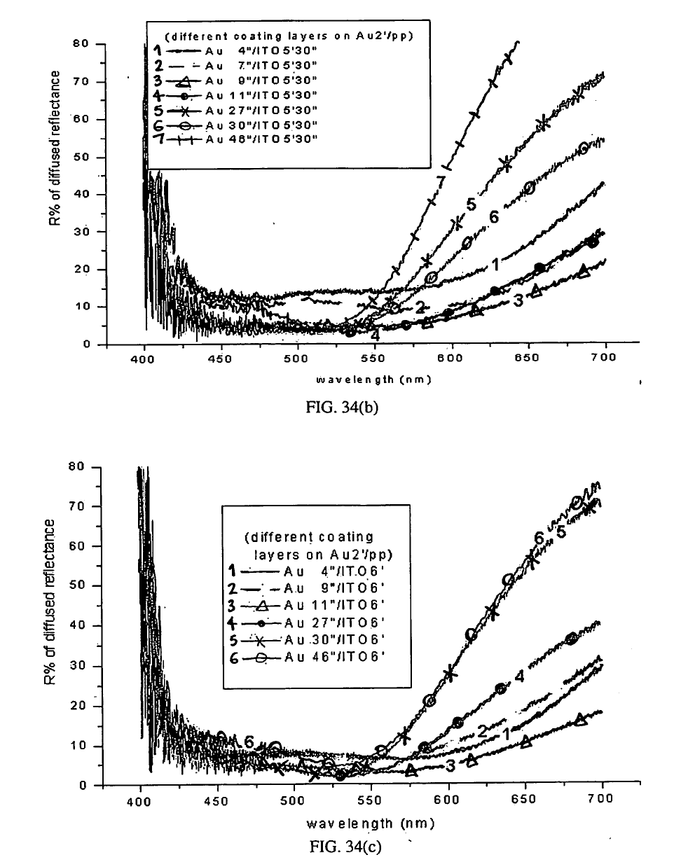

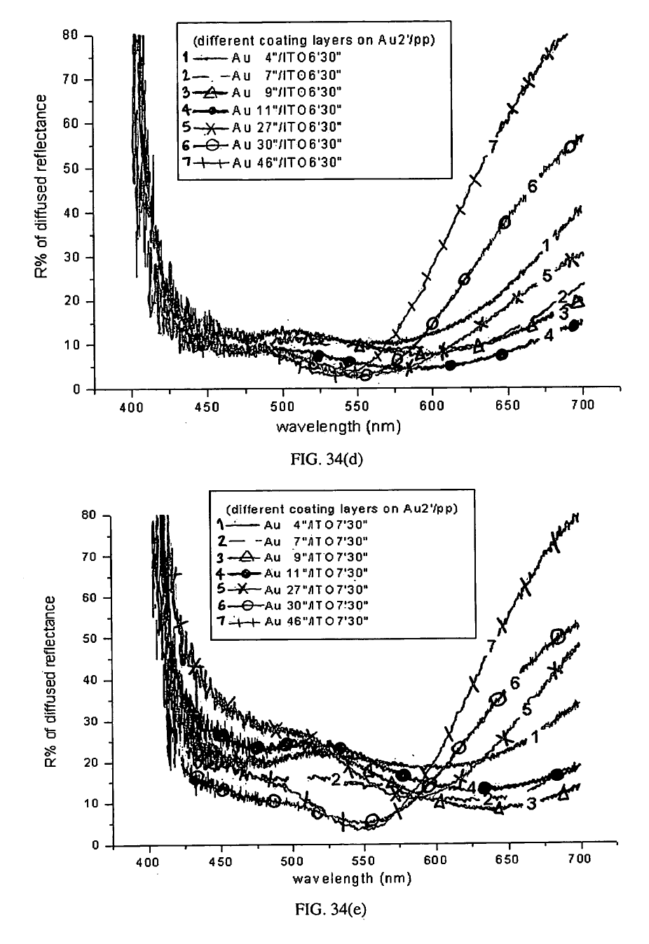

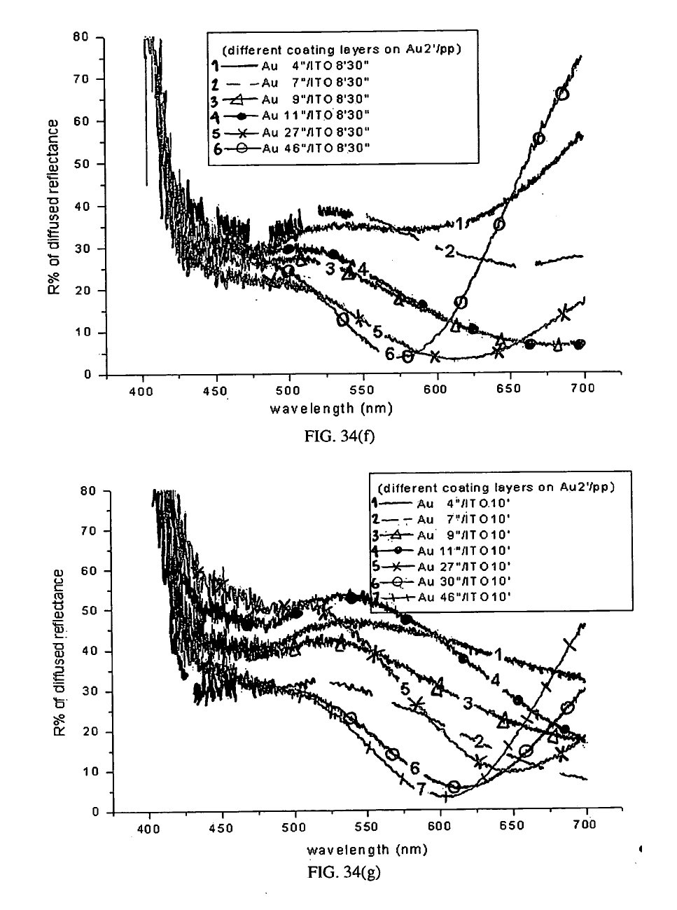

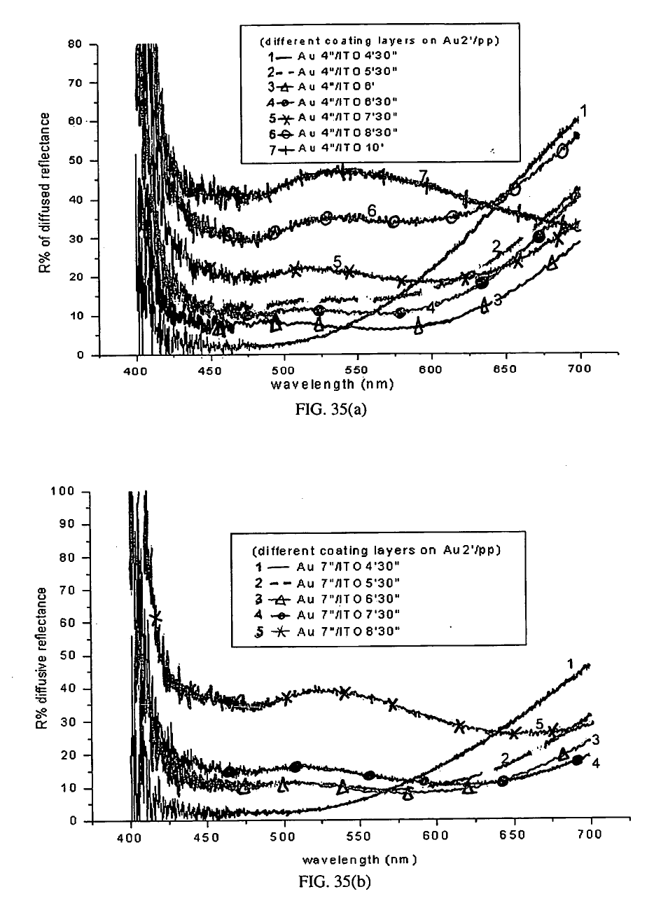

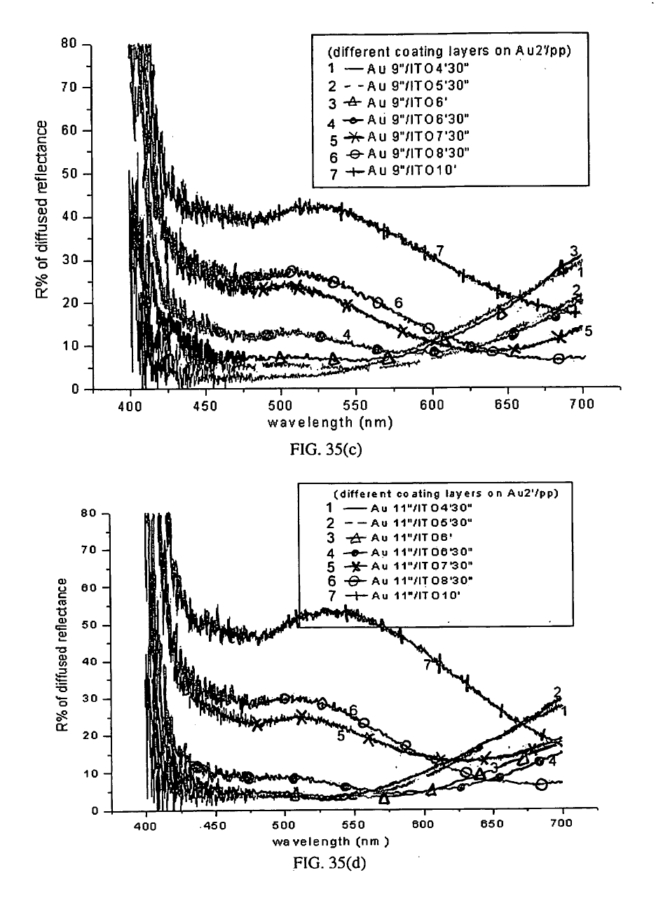

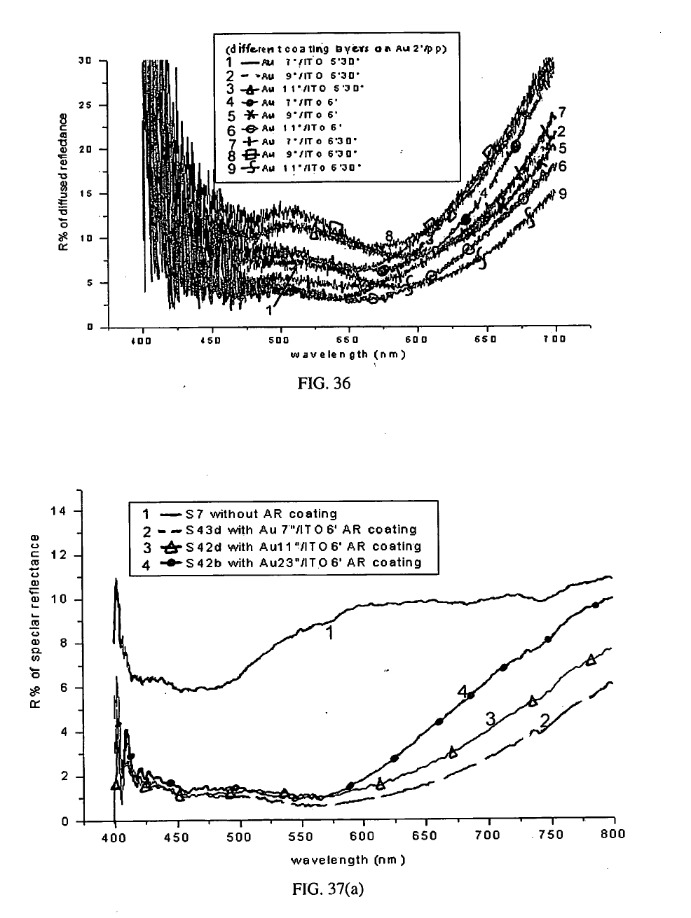

The measurement results are shown in FIG. 34, which are organized in a group based on the sputtering time of ITO layers. To compare among these spectra as it was done in the case of specular reflection spectra, some spectra of samples with better performance are organized in FIG. 35 based on the sputtering time of ultra-thin gold layers. When the sputtering time of the ultra-thin gold layer is from 7 to 11 seconds and the sputtering time of the ITO layer is from 5′30″ to 6′30″, the AR coatings exhibit better performance of decreasing the diffuse reflection than other AR coatings with different sputtering times of the constituent layers. Spectra with lower reflectance in FIG. 35 are selected and displayed in FIG. 36. Finally the lower spectra in FIG. 36 were smoothened by the adjacent averaging function in the Origin software. Then areas included by these selected spectra in the visible wavelength range from 425 nm to 700 nm were calculated and results are shown in Table 6. The wavelength region from 400 nm to 425 nm was neglected in the calculation due to the measurement noise.

Table 6 shows that AR coatings with the ultra-thin layer formed by 11 seconds of sputtering time not only have lower integration areas than others when the sputtering time of the ultra-thin layer is 7 and 9 seconds, but also have the lowest integration area among them, which is 1821.73 (nm) with constituent layers of Au 11″/ITO 6′. However, considering the high transmittance of AR coatings needed, Au 7″/ITO 6′, Au 7″/ITO 6′30″, Au 9″/ITO 5′30″, or expressed as thickness, Au 9″/ITO 6′, as well as Au (3.44 nm)/ITO (425 Å), Au (3.44 nm)/ITO (454 Å), Au (4.01 nm)/ITO (395 Å), Au (4.01 nm)/ITO (425 Å) are also good constituent layers for AR coatings to have good performance. The average reflectance of these samples in the visible wavelength range is around 8 to 12%.

TABLE 6
Integration areas of diffuse reflection spectra ranging from
425 to 700 nm for lower spectra of samples in FIG. 36

| | Sputtering time of | |
|---|---|---|
| | related AR coating | Integration |
| Sample # | layers | areas(nm) |
| 2-7 | Au 7″/ITO 5′30″ | 3672.57 |
| 7-7 | Au 7″/ITO 6′ | 2930.66 |
| 3-7 | Au 7″/ITO 6′30″ | 3196.23 |
| 2-2 | Au 9″/ITO 5′30″ | 2241.42 |
| 7-2 | Au 9″/ITO 6′ | 3292.15 |
| 3-2 | Au 9″/ITO 6′30″ | 3326.92 |
| 2-1 | Au 11″/ITO 5′30″ | 2647.70 |
| 7-1 | Au 11″/ITO 6′ | 1821.73 |
| 3-1 | Au 11″/ITO 6′30″ | 2231.59 |

In summary, considering high transmittance of AR coatings to be necessary and low specular reflections and low diffuse reflections as needed, AR coatings have better performance on polypropylene sheets when the sputtering time of ultra-thin gold layers ranges from 7 to 9 seconds and sputtering time of ITO layers ranges from 6′ to 6′30″ or when ultra-thin gold layer thickness ranges from (3.44±0.28) nm to (4.01±0.29) nm and thickness of ITO layers ranges from (425±29) Å to (455±30) Å. The average reflectances of specular and diffuse reflection in the visible wavelength range are about 5% and 12% respectively for AR coatings on the polypropylene sheets.

### AR Coatings on SSTFEL Devices

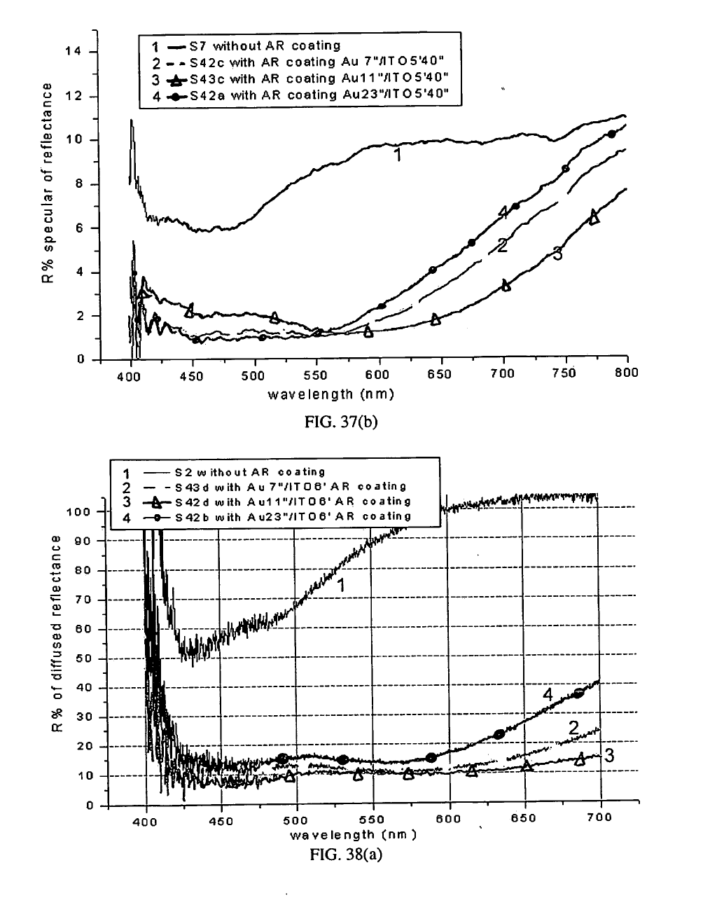

After the AR coatings were applied on the surface of SSTFEL devices, the specular and diffuse reflectance of the devices are 3 or 5 times lower than that of devices without AR coatings. FIGS. 37 and 38 show these measurement results. The diffuse reflection is always larger than the specular reflection because the surface of devices is highly packed with spheres with diameter of 50 μm. Integration areas of specular reflection spectra ranging from 410 to 700 nm in FIG. 37 for SSTFEL devices with or without AR coating are displayed in Table 7, which were calculated in the same way used above. Integration areas of diffuse reflection spectra ranging from 425 to 700 nm in FIG. 38 for the same SSTFEL devices with or without AR coating are shown in Table 8.

Comparing the data in Tables 7 and 8 and considering the high transmittance of AR coatings to be necessary, AR coatings have better performance to reduce specular and diffuse reflection of SSTFEL devices while the sputtering time of the ultra-thin gold layer is 7 seconds, and 6 minutes for the ITO layer, corresponding to the thickness of (3.44±0.28) nm and (425±30) Å respectively. The average reflectance of specular and diffuse reflections in visible wavelengths is 1.3% and 13.6%, respectively.

TABLE 7
Integration areas of specular reflection spectra ranging
from 410 to 700 nm in FIG. 37 for SSTFEL devices
with different AR coating layers

| | Sputtering time of | |
|---|---|---|
| | related AR coating | Integrated |
| Sample # | layers | areas(nm) |
| S42c | Au 7″/ITO 5′40″ | 572.23 |
| S43d | Au 7″/ITO 6′ | 371.11 |
| S43c | Au 11″/ITO 5′40″ | 551.15 |
| S42d | Au 11″/ITO 6′ | 493.73 |
| S42d | Au 23″/ITO 5′40″ | 664.36 |
| S42b | Au 23″/ITO 6′ | 668.98 |
| S2 | Without AR coating | 2374.29 |

TABLE 8
Integration areas of diffuse reflection spectra ranging
from 425 to 700 nm in FIG. 38 for SSTFEL devices
with different AR coating layers

| | Sputtering time of | |
|---|---|---|
| | related AR coating | Integrated |
| Sample # | layers | areas(nm) |
| S42c | Au 7″/ITO 5′40″ | 7020.42 |
| S43d | Au 7″/ITO 6′ | 3750.31 |
| S43c | Au 11″/ITO 5′40″ | 4343.69 |
| S42d | Au 11″/ITO 6′ | 2884.59 |
| S42d | Au 23″/ITO 5′40″ | 5406.81 |
| S42b | Au 23″/ITO 6′ | 5342.39 |
| S11 | Without AR coating | 23363.14 |

### Contrast of SSTFEL Devices with AR Coatings

The contrast ratio of SSTFEL devices with or without the AR coatings was measured and compared in the different illumination conditions by a method of Full On/Off, a widely used measurement method in the video display industry. According to the Full On/Off method, the ratio of the light output white image (full on) and light output of an all black (full off) is expressed as

$$contrast ratio = \frac{{L}_{pixel \text{-} on}}{{L}_{pixel \text{-} off}} = \frac{{L}_{El \text{-} on} + {L}_{reflect}}{{L}_{EL \text{-} off} + {L}_{reflect}} \qquad ( 32 )$$

where Lₚᵢₓₑₗ₋ₒₙ means the luminance of light output from the surface of the SSTFEL device under the application of a AC voltage. It is the sum of L_{EL-on} and L_{reflect}. L_{EL-on} is the luminance of light output from pixels of the SSTFEL device under the application of the pulse voltage, and L_{reflect} is luminance of reflected ambient light from the surface of the SSTFEL device; L_{pixel-off} means the luminance of light output from the SSTFEL device without the application of the pulse voltage. It is the sum of L_{EL-off} and L_{reflect}. L_{EL-off} is zero for the SSTFEL device without the application of the AC voltage. As a pulse voltage with the zero-to-peak of 250 (V) and frequency of 745 Hz was applied to the SSTFEL device, Lₚᵢₓₑₗ₋ₒₙ and L_{pixel-off} were measured as “Pixel ON/OFF” by Luminance Meter LS-100 of Minolta Camera Co. Ltd. under different illumination conditions in the lab. Measurement results are presented in the Table 9.

The measurement results of SSTFEL devices with or without AR coatings under different ambient illumination conditions are presented in Table 9. The contrast ratio of SSTFEL devices with AR coatings is (15.4±0.9):1 at the ambient illumination level of (200.0±7.2) Lux, and increases to (47.9±2.0):1 as the ambient illumination level decreases to (52.6±1.6) Lux. Whether the ambient illumination level is high or low, the contrast ratio of SSTFEL devices with AR coatings is 3 to 5 times higher than the contrast ration of SSTFEL devices without AR coatings.

TABLE 9
Contrast of SSTFEL devices with or without AR coating
system under different luminance conditions

| | | Pixel | L(average) | SSTFEL Device |
|---|---|---|---|---|
| | Sample # | state | (cd/m²) | Contrast |
| Ambient | 200.0 ± 7.1 Lux (turn off some of office lights) | | | |
| illumination | | | | |
| SSTFEL | S41 | Pixel on | 79.3 ± 1.3 | (15.4 ± 0.4):1 |
| devices | | Pixel off | 5.13 ± 0.11 | |
| (with AR | | | | |
| coating) | | | | |
| SSTFEL | S7 | Pixel on | 123.5 ± 1.5 | (3.0 ± 0.1):1 |
| devices | | Pixel off | 41.39 ± 1.5 | |
| (without AR | | | | |
| coating) | | | | |
| Ambient | 52.6 ± 1.6 Lux (turn off some of office lights) | | | |
| illumination | | | | |
| SSTFEL | S41 | Pixel on | 70.3 ± 0.8 | (47.9 ± 1.0):1 |
| devices | | Pixel off | 1.47 ± 0.03 | |
| (with AR | | | | |
| coating) | | | | |
| SSTFEL | S7 | Pixel on | 87.0 ± 1.1 | (15.8 ± 0.3):1 |
| devices | | Pixel off | 5.51 ± 0.08 | |
| (without AR | | | | |
| coating) | | | | |

### Setup of Model for AR Coatings on Polypropylene Sheets, Simulation Results and Discussion

### Model for the Reflectance Simulation of Ar Coatings on Polypropylene Sheets

The structure of AR coatings on polypropylene sheets is shown in FIG. 39. The thickness of an ultra-thin gold layer on the top of ITO layer is around from 3 to 5 nm, and the thickness of an ITO layer is around 45 nm. A thick gold layer with the thickness of around 36 nm is sputtered by S150B Sputter Coater for 120 second on the propylene sheets.

When the sputtering time is limited to several seconds, the ultra-thin gold layers will be less than 5 nm thick, too thin to be regarded as a solid optical film. According to the reflectance spectra of ultra-thin gold layers on Si substrates and glass substrates shown in the FIGS. 29 and 30, it can be assumed that the surface of AR coatings with the ultra-thin gold layer is regarded as a complex surface with the following properties:

Reflectance is equal to the sum of the reflectance of material below the ultra-thin gold layer and reflectance increment after the ultra-thin gold layer is sputtered on it. Thus its reflectance can be expressed as

R₁=R_{ITO}+ΔR_{Au-on-ITO} (33)

There is no phase change of the light wave in the internal reflection from this complex surface due to the ultra-thin gold layer composed of dense tiny islands with high resistance. Internal reflectance coefficient r₁ can be expressed as

r₁=\sqrt{R₁} (34)

where R₁ is the reflectance of this complex surface. For the external reflection, the reflectance coefficient is

r₁′=r₁. (35)

### If the incident light is expressed as E₀e^{iωt}, the intensity of incident light and a reflected beam are expressed as

I₀=(E₀e^{iωt})×(E₀e^{iωt})*=E₀² (36)

I_{R1}=(r₁E₀e^{iωt})×(r₁E₀e^{iωt})*=r₁r₁*E₀²=R₁I₀ (37)

where (E₀e^{iωt})* and (r₁E₀e^{iωt})* are the conjugates of (E₀e^{iωt}), (r₁E₀e^{iωt}) respectively.

The phase change of the light wave can be neglected due to the low thickness of the ultra-thin gold layer. The intensity of incident light passing the ultra-thin gold layer is

I_{Au}=(t₁E₀e^{iωt})×(t₁E₀e^{iωt})*=t₁t₁*E₀²=T₁I₀ (38)

where t₁ is the transmittance coefficient of the ultra-thin gold layer, and t₁=t₁*. Thus t₁ can be expressed as

t₁=\sqrt{T₁} (39)

where T₁ is transmittance of the ultra-thin gold layer shown in the FIG. 41. Reflectance coefficient of the ITO/Au interface is assumed and expressed as

r₂=\sqrt{R₂}e^{-iΔ} (40)

where R₂ is reflectance of the ITO/Au interface shown in FIG. 39, and Δ is the phase change of the ITO/Au interface shown in FIG. 41. It cannot be assumed that Δ is still π even if the thick gold layer is a physically continuous film with thickness of 36 nm. However optical properties of this thick gold layer are different from that of bulk gold for two reasons: first, its reflectance spectrum is different from that of bulk gold as shown in FIG. 30, and it is not opaque in the visible wavelength range as is the case with bulk gold; second, the surface of this thick gold layer on polypropylene sheets does not look like a smooth mirror due to the annealing processes. Therefore Δ will be treated as a parameter in the simulation.

When the light passes through the ITO layer, its intensity decreases further and can be expressed as

I_{ITO}=(t₂(t₁E₀e^{i(ωt)})e^{-iδ})×(t₂(t₁E₀e^{i(ωt)})e^{-iδ})*=t₂t₂*t₁t₁*E₀²

I_{ITO}=T₂T₁E₀² (41)

where δ is the phase change of the light wave resulting from passing through the ITO layer, and t₂ is the transmittance coefficient of the ITO layer and t₂=t₂*. Thus, t₂ can be expressed as

t₂=\sqrt{T₂} (42)

where T₂ is the transmittance of the ITO layer shown in the FIG. 39.

The transmittance spectra of gold layers in FIG. 29 shows that the transmittance of a thick gold layer is lower than 30 percent in most of the range of visible wavelengths when its sputtering time is 90 seconds. For a gold layer with a sputtering time of 120 seconds, its transmittance will be less than 30 percent in the visible wavelength range. Therefore, we can neglect approximately the effect of the reflected light from the interface behind this thick gold layer in simulation.

### The Reflectance of the AR Coating on Polypropylene Sheets

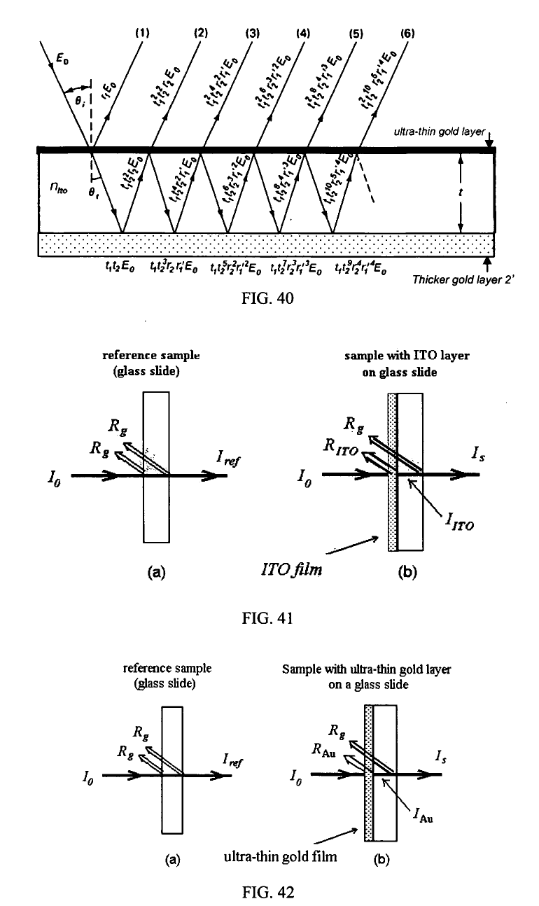

Because it is difficult to measure indexes of two gold layers, the multiple-beam interference method is selected to calculate the reflectance of AR coatings on a thick gold layer by considering the superposition of the reflected beams shown in the FIG. 40. The phase difference between successive beams due to passing an ITO layer at close to normal incident angle is given as

$$δ = 2 * \frac{2 π}{{λ}_{0}} * {n}_{ITO} {d}_{ITO} \qquad ( 43 )$$

here n_{ITO} and d_{ITO} are the refractive index and thickness of an ITO layer respectively. If the incident light is expressed as E₀e^{iωt}, the successive reflected beams can be expressed by appropriately modifying both the amplitude and phase of the initial wave. Referring to FIG. 40, there are

E₁=(r₁E₀)e^{iωt}

E₂=(t₁²t₂²r₂E₀)e^{i(ωt-δ)}

E₃=(t₁²t₂⁴r₂²r₁E₀)e*^{i(ωt-2δ)}

E₄=(t₁²t₂⁶r₂³r₁′²E₀)e^{i(ωt-3δ)}

E₅=(t₁²t₂⁸r₂⁴r₁′³E₀)e^{i(ωt-4δ)}

E₆=(t₁²t₂¹⁰r₂⁵r₁′⁴E₀)e^{i(ωt-5δ)}

and so on, where r₂ is the reflectance coefficient of the interface between the ITO layer and the thick gold layer. Nth such reflected wave can be written as

E_{N}=(t₁²t₂^{2(N-1)}r₂^{N-1}r₁′^{N-2}E₀)e^{i(ωt-(n-1)δ)} (44)

a form that holds for all but E₁. Therefore, the resulting E_{R} may be written as

$$\begin{matrix}{E}_{R} = {\sum }_{n = 1}^{∞} {E}_{N} & ( 45 ) \\ {E}_{R} = {r}_{1} {E}_{0} {e}^{i ω t} + {\sum }_{N = 2}^{∞} ( {t}_{1}^{2} {t}_{2}^{2 ( N - 1 )} {r}_{2}^{N - 1} {r}_{1}^{′ N - 2} {E}_{0} ) {e}^{i ( ω t - ( N - 1 ) δ )} \\ {E}_{R} = {E}_{0} {e}^{i ω t} [ {r}_{1} + {t}_{1}^{2} {t}_{2}^{2} {r}_{2} {e}^{- i δ} \times {\sum }_{N = 2}^{∞} ( {t}_{2}^{2 ( N - 2 )} {r}_{2}^{N - 2} {r}_{1}^{′ N - 2} ) {e}^{- i ( N - 2 ) δ} ] & ( 46 )\end{matrix}$$

### The summation is now in the form of a geometric series,

$$\begin{matrix}{\sum }_{N = 2}^{∞} {x}^{N - 2} = 1 + x + {x}^{2} + {x}^{3} + … ; \\ where & ( 47 ) \\ x = {t}_{2}^{2} {r}_{2} {r}_{1}^{′} {e}^{- i δ} & ( 48 )\end{matrix}$$

### Since |x|<1, the series converges to the sum S=1/(1−x). Thus

$${E}_{R} = {E}_{0} {e}^{i ω t} [ {r}_{1} + \frac{{t}_{1}^{2} {t}_{2}^{2} {r}_{2} {e}^{- i δ}}{1 - {t}_{1}^{2} {r}_{2} {r}_{1}^{′} {e}^{- i δ}} ] \qquad ( 49 )$$

### The reflectance of AR coatings is

$$R = \frac{{E}_{R} {E}_{R}^{*}}{{E}_{0}^{2}} = {\vert ( {r}_{1} + \frac{{t}_{1}^{2} {t}_{2}^{2} {r}_{2} {e}^{- i δ}}{1 - {t}_{2}^{2} {r}_{2} {r}_{1}^{′} {e}^{- i δ}} ) \vert}^{2} \qquad ( 50 )$$

### After replacing r₁ r₁′ and r₂ by formulas (34), (35) and (40), and replacing t₁ and t₂ by (39) and (42) respectively, (50) is simplified to,

$$R = {R}_{1} + \frac{{T}_{1}^{2} {T}_{2} {R}_{2} + 2 {T}_{1} {T}_{2}^{2} {R}_{1} {R}_{2} + 2 {T}_{1} {T}_{2} \sqrt{{R}_{1} {R}_{2}} cos ( δ + Δ )}{1 + {T}_{2}^{2} {R}_{1} {R}_{2} + 2 {T}_{2} \sqrt{{R}_{1} {R}_{2}} cos ( δ + Δ )} \qquad ( 51 )$$

where T₁ and T₂ are the transmittance of the ultra-thin gold layer and the ITO layer respectively. R₁ is the reflectance defined in expression (33). R₂ is the reflectance of the thick gold layer on the polypropylene sheet.

### Extracting Transmittance Spectra of the Ultra-Thin Gold Layer and the ITO Layer From Experimental Results

Transmittance spectra of ITO films and ultra-thin gold films were measured by a Cary 50 Probe UV Visible Spectrophotometer after they were deposited on a glass substrate, which are shown in FIGS. 21 and 29. During measurement, the same glass substrate was measured as a reference sample. The measured transmittance of the ITO film on the glass is given by

$${T}_{ITO\_measured} = \frac{{I}_{s}}{{I}_{ref}} \qquad ( 52 )$$

where I_{ref} and Iₛ are the intensity of incident light after passing a reference sample and samples with an ITO film respectively. Both of them are shown in FIGS. 41(a) and (b). In the FIG. 41, I₀ is the intensity of incident light. The reflection of light from the two sides of the glass can be assumed to be the same and labeled R_{g} in FIG. 41(a).

Considering reflections of surfaces and interfaces in measurement, expression (52) can be expressed approximately as

$${T}_{ITO\_measured} \approx \frac{{I}_{0} ( 1 - {R}_{ITO} - {R}_{g} )}{{I}_{0} ( 1 - 2 {R}_{g} )} \qquad ( 53 )$$

where R_{ITO} simply expresses the reflectance of the ITO layer on the glass. It includes two parts; one is the reflection from the ITO surface, the other is the reflection from the interface between the ITO layer and the glass.

Because R_{g}=0.04, 1/(1−R_{g})≈1+R_{g}. Expression (53) can be approximately simplified as

T_{ITO}_{_{—}}_{measured}≈(1−R_{ITO}−R_{g})×(1+2R_{g})≈1−R_{ITO}+R_{g} (54)

### On the other hand, the transmittance of the ITO film can be expressed as

$$\begin{matrix}{T}_{2} \approx \frac{{I}_{0} ( 1 - {R}_{ITO} )}{{I}_{0}} = 1 - {R}_{ITO} \\ Thus & ( 55 ) \\ {T}_{2} = {T}_{ITO\_measured} - {R}_{g} & ( 56 )\end{matrix}$$

### Therefore the transmittance of the ITO film is equal to the difference between direct measured transmittance of the ITO layer on the glass and the reflectance of the glass surface.

Similarly the transmittance of ITO films, the transmittance of the ultra-thin gold film shown in FIG. 42 can be expressed as

T₁(λ)=T_{Au}_{_{—}}_{measured}(λ)−R_{g}(λ) (57)

### Extracting Reflectance Spectra of the Complex Surface and Interface Between ITO Layer and Thick Gold Layer From Experimental Results

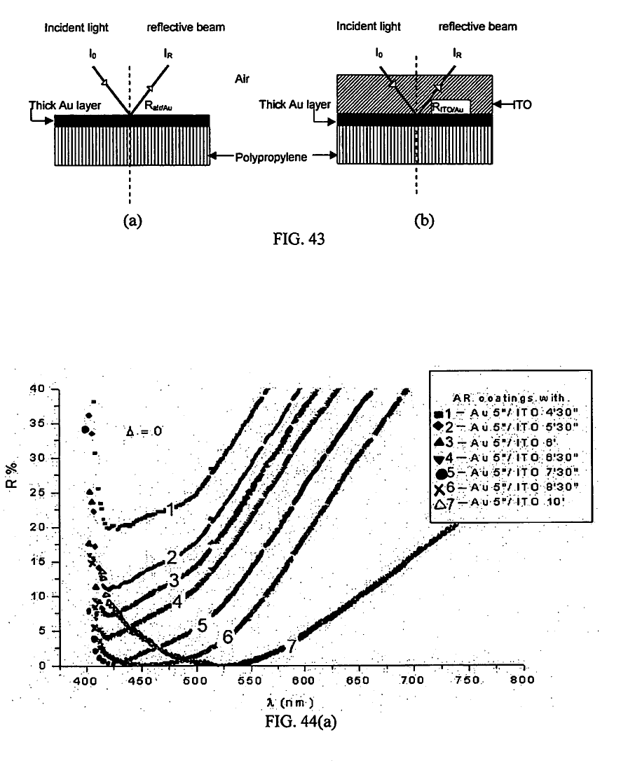

Due to the fact that ITO films with the thickness comparable to that of glass slides is unavailable, it is difficult to directly measure the reflectance of ultra-thin gold layers on the ITO film without the interference effect. Further, it is impossible to directly measure the reflectance of the interface between ITO layer and thick gold layer shown in FIG. 43(b).

Based on the experimental results shown in FIGS. 27 and 28, the reflectance spectrum of the ultra-thin gold film whether on the Si substrate or on the glass substrate is similar to the reflectance spectrum of the substrate, and following the reflectance spectrum of the substrate but increasing by several percent. It is reasonable to assume that the reflectance spectrum of the ultra-thin gold film on the ITO film, the complex surface in the model, is also equal to the sum of the ITO reflectance spectrum and several percent increment. It is expressed as

R₁=R_{ITO}+ΔR_{Au-on-ITO} (58)

where R_{ITO} is the reflectance of the ITO film and ΔR_{Au-on-ITO} is the reflectance increment after the ultra-thin gold layer is sputtered on the ITO film. For simplifying the reflectance simulation of AR coatings, ΔR_{Au-on-ITO} is replaced by ΔR_{Au-on-Glass} because the index of a glass slide substrate being closer to the index of ITO layer. Thus R₁ in expression (58) is expressed as

R₁≈R_{ITO}+ΔR_{Au-on-glass} (59)

For simplification in the reflectance simulation of AR coatings, it is assumed approximately that the index of refraction of the ITO film deposited under sputtering conditions in this work is constant in the visible wavelength range. R_{ITO} in the normal incident situation is

$${R}_{ITO} = {( \frac{{n}_{air} - {n}_{ITO}}{{n}_{air} + {n}_{ITO}} )}^{2} \qquad ( 60 )$$

where nₐᵢᵣ is the index of air and n_{ITO} is the index of the ITO layer, 1.97. So R₁ can be expressed as

$${R}_{1} = Δ {R}_{Au \text{-} on \text{-} glass} + {( \frac{{n}_{air} - {n}_{ITO}}{{n}_{air} + {n}_{ITO}} )}^{2} \qquad ( 61 )$$

### ΔR_{Au-on-Glass} can be obtained from experimental data shown in FIG. 35.

The reflectance of ITO/Au interface is replaced by the reflectance of the Air/Au interface shown in FIG. 43(a). Thus the reflectance coefficient of the ITO/Au interface can be expressed as

r₂=\sqrt{R₂e}^{-iΔ}=\sqrt{R_{air/Au}}e^{-iΔ} (62)

where Δ is the phase change of ITO/Au interface shown in FIG. 43(b). R_{air/Au} is the reflectance of air/Au interface shown in FIG. 43(a) and its measurement result is shown in FIG. 30.

### Calculating Reflectance of AR Coatings on Polypropylene Sheets

Based on assuming the phase change of the reflected light on the surface of AR coatings be zero in the model, the smaller the thickness of the ultra-thin gold layer, the better the approximation of this model to calculate the reflectance of AR coatings. The reflectance simulation was applied on the AR coatings composed of different ITO layers and ultra-thin gold layers with sputtering times of 5 seconds and 12 seconds. Simulation results of AR coating reflectance are shown in FIGS. 51 and 52. Because the transmittance of ITO layers with sputtering times of 5′, 6′ and 6′30″ have only been measured, the transmittance of ITO layers with sputtering times of 4′30″ and 5′30″ were approximately replaced by the experimental data of the ITO layer with sputtering time of 5′. The transmittance of ITO layers with sputtering times of 7′30″, 8′30″ and 10′ were approximately replaced by the experimental data of the ITO layer with sputtering time of 6′30″ in the calculation.

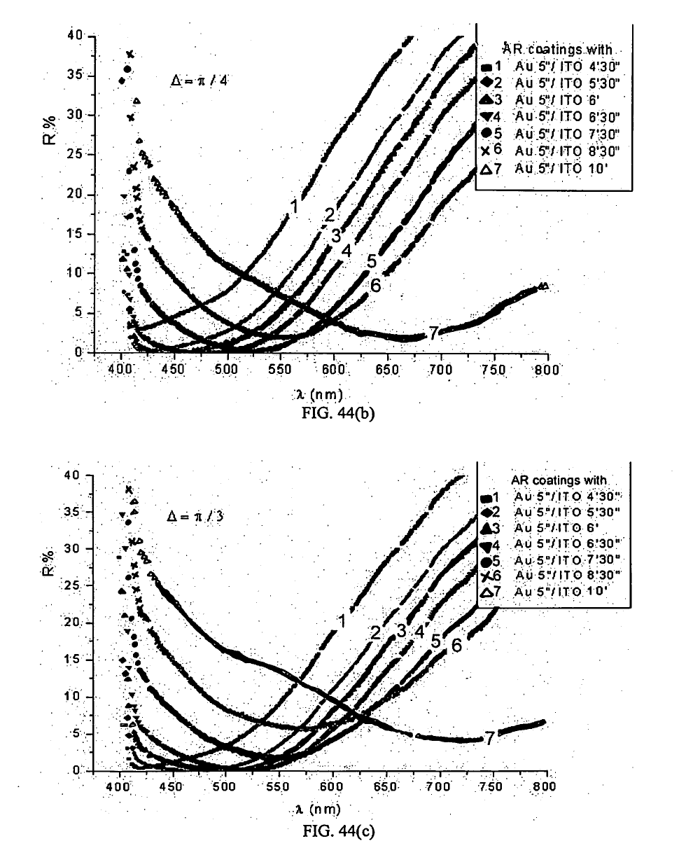

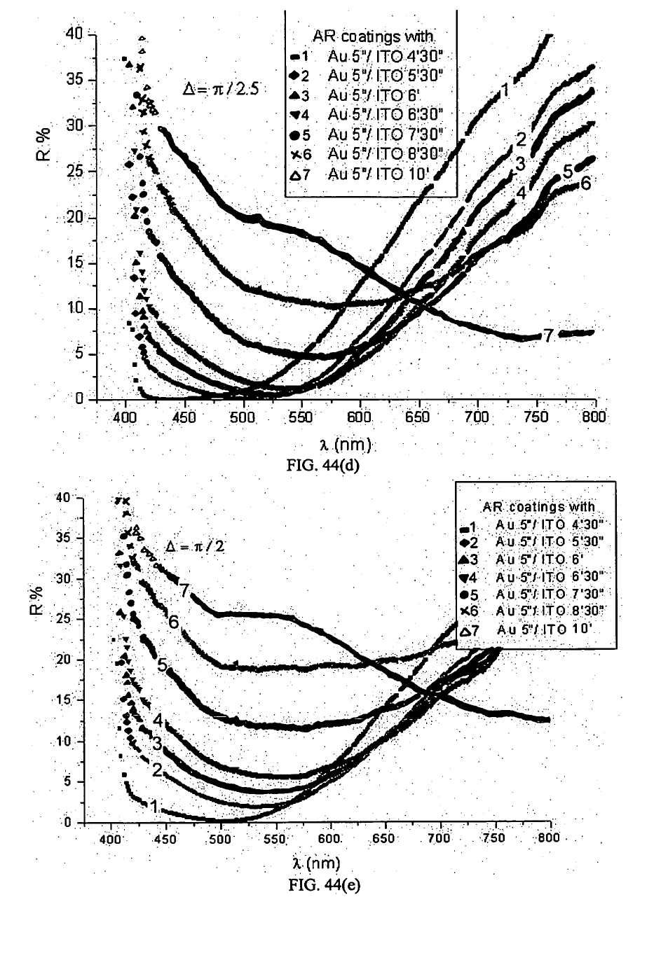

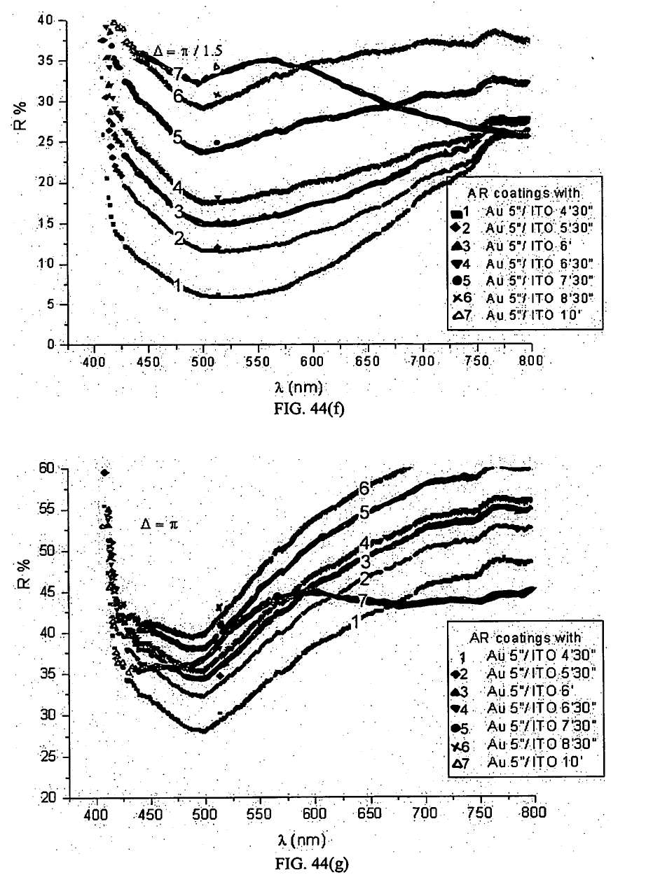

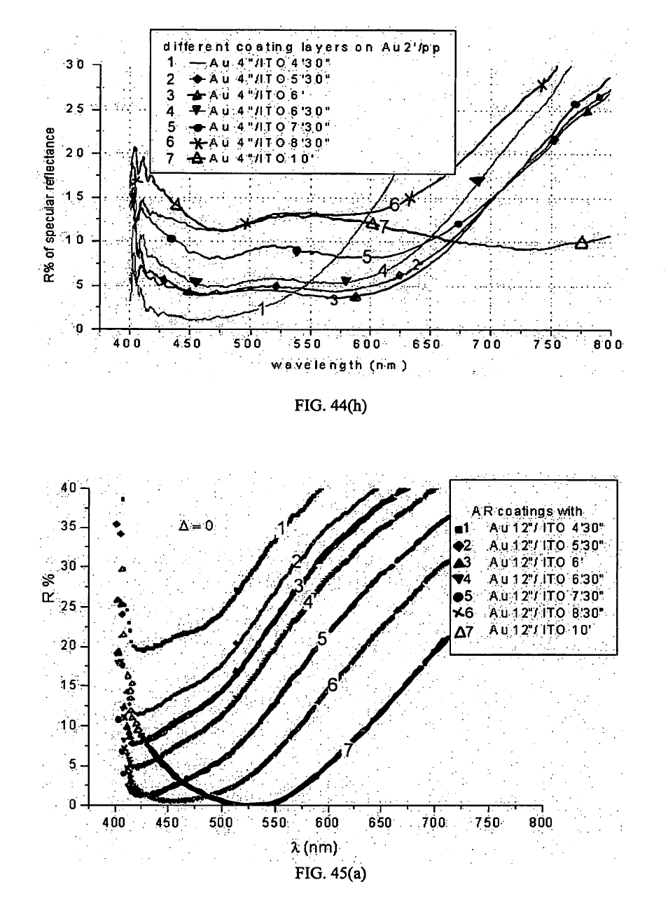

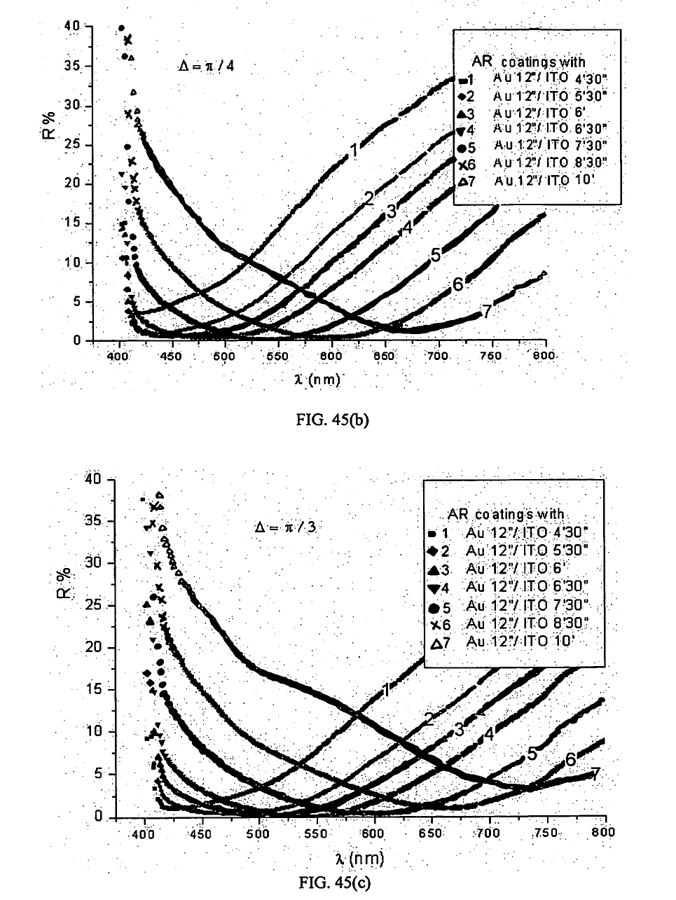

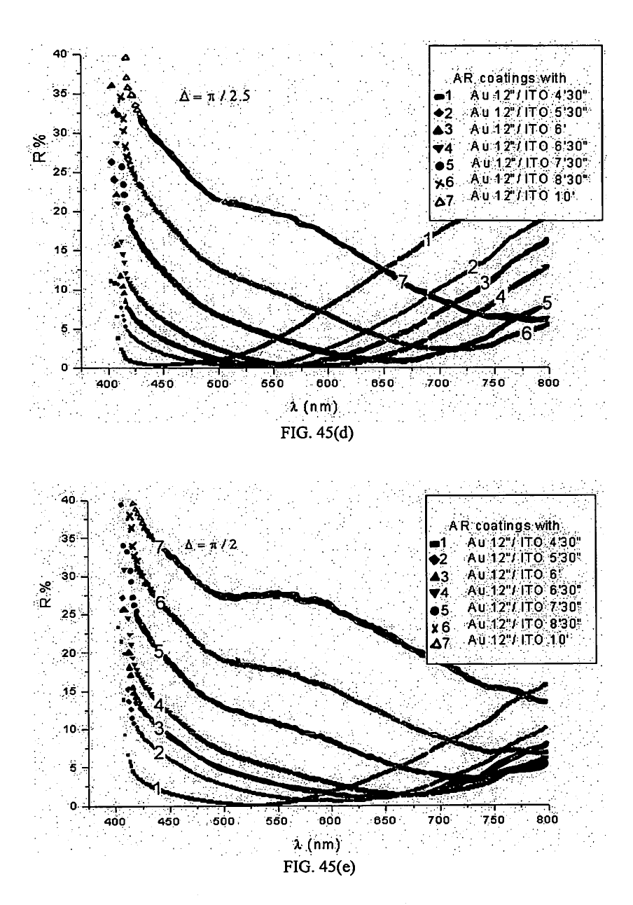

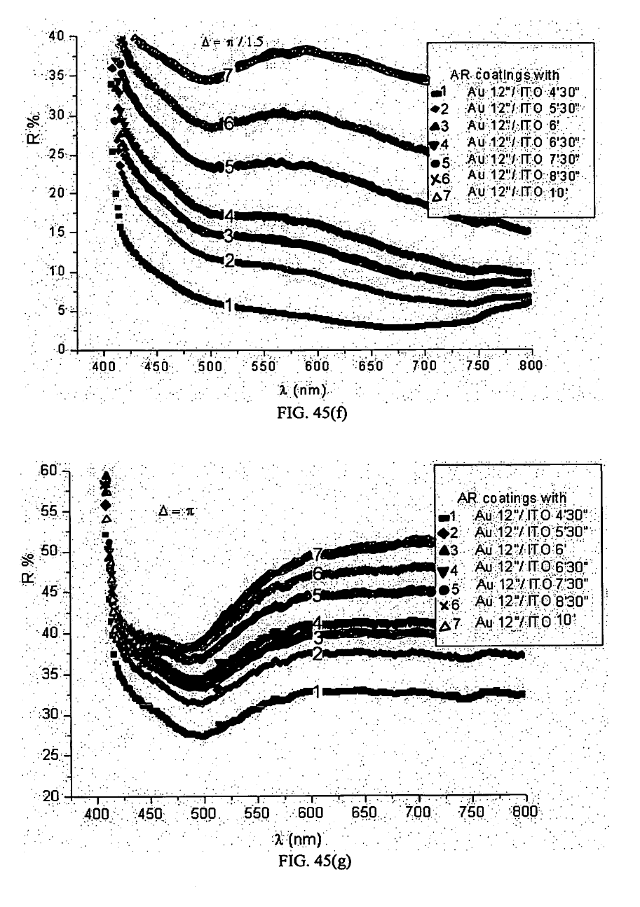

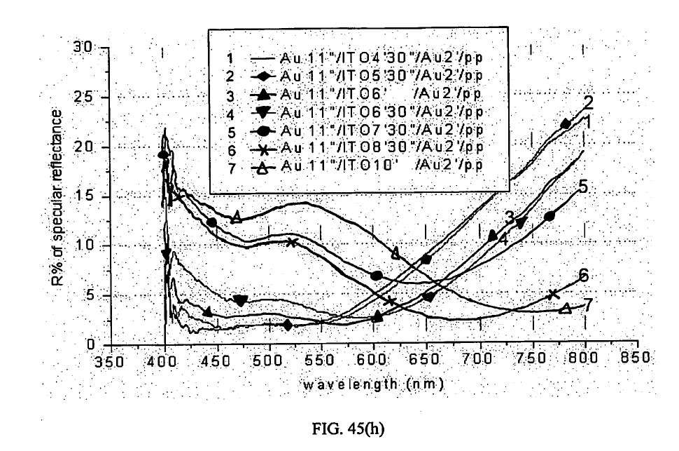

To compare each group of reflectance spectra in FIG. 44 one group was made in FIG. 44(h), which is the experimental results of AR coatings composed of ultra-thin gold layers with sputtering times of 4 seconds and the same thickness of different ITO layers; it can be seen clearly that spectral curves in FIG. 44(e) have similar relative position and variation in visible wavelengths to those of spectral curves in FIG. 44(h). Similarly, in FIG. 45, the spectral curves in FIG. 45(d) have similar relative position and variation in visible wavelengths to those of spectral curves in FIG. 45(h). The simulation results show that the phase change of Δ is around π/2.5.

Although, the simulation reflectance of AR coatings does not match exactly with the measurement value of the reflectance of AR coatings due to the approximate calculation in the simulation and the effect of diffused reflection from the thick gold layer, the match of the spectral variation trends at two end ranges of visible wavelengths and their similarity in detail at the mid range of visible wavelengths show that the model and assumptions for simulating reflectance of AR coatings on polypropylene sheets can predict the basic features of experimental curves.

### CONCLUSION

The coating of this invention serves as an antireflection coating and also optimizes a high contrast ratio that is at least 3 times higher than that of SSTFEL devices without AR coatings.

The AR coating is composed of an ultra-thin gold layer and an ITO layer. In the present invention, the index, transmittance spectrum and sheet resistance of ITO films related to sputtering conditions have been studied. At the deposition conditions of RF power of 30 W, chamber pressure of 0.5 mTorr and Ar flow ratio of 7.0 sccm, ITO films have high transmittance over 75% in visible wavelength and good conductivity with sheet resistance of 131.2±6.1Ω/□. The refractive index is 1.97. It was found the propylene sheets crinkle and wrinkle during the deposition process at RF power of 45 W.

The ultra-thin gold layer is an adjusting layer of reflection intensity in AR coatings. Its transmittance and reflectance spectra are important in the AR coatings and have been measured. Results from the measurement of its reflectance spectra show that its reflectance spectrum is totally different from bulk gold when its thickness is less than 10 nm. It then appears the reflectance spectrum of substrates increases several percent. However, as its thickness increases over to 30 nm, its reflectance spectrum is some similar to that of bulk gold.

AFM technology was also utilized to image the surface morphology of ultra-thin gold layers and to measure thickness. AFM images suggest that the surface morphology of ultra-thin gold films are similar whether on Si substrates, on propylene sheets or on the surface of ITO films. Therefore the measured sputtering speed of the ultra-thin gold film on the Si substrate by AFM technology can be used to evaluate the thickness of the ultra-thin gold layer sputtered on polypropylene sheets under the same sputtering conditions.

In order to maximize the destructive interference of ambient light at visible wavelengths, a number of samples were made by depositing AR coatings on propylene sheets and SSTFEL devices, which were composed of different thicknesses of ITO layers and ultra-thin gold layers. Specular and diffuse reflection spectra of samples have been measured and compared. Areas under spectral curves of reflection with good performance AR coatings were integrated over visible wavelengths from 410 or 425 to 700 nm. Considering the high transmittance of AR coatings needed, results show that AR coatings exhibit the best performance in reducing the surface reflection of samples as the thickness of ultra-thin gold layers ranges from 3.4 to 4.0 nm and thickness of ITO layers ranges from 424 to 450 Å.

Sheet resistance of two groups of ultra-thin gold layers sputtered on the top of ITO layers show that the conductivity of the ultra-thin gold layer improves as thickness of the ultra-thin gold film decreases to a certain value despite the fact that it is expected to be worse according to the theory of tunneling effects that has been reported.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

Exemplary embodiments have been provided herein; however it is noted that the invention can be practiced in other ways that will occur to those skilled in the art. Accordingly, the invention is not limited to the examples presented herein, but is given the broadest scope defined by the following claims.

What is claimed is:

1. An antireflection layer for a flexible emissive electroluminescent (EL) device, comprising a layer of indium tin oxide (ITO) covering the surface of a flexible emissive EL device, and a layer of metal on top of the layer of indium tin oxide covering the surface of a flexible emissive electroluminescent device.

2. The antireflection layer of claim 1, wherein the flexible emissive EL device is ceramic based.

3. The antireflection layer of claim 2, wherein the flexible emissive electroluminescent device is a sphere supported thin film electroluminescent (SSTFEL) device.

4. The antireflection layer of claim 3, wherein the surface of the flexible emissive electroluminescent device comprises ceramic sphere regions and polymer regions.

5. The antireflection layer of claim 4, wherein the ceramic sphere regions are coated with an EL phosphor layer, said layer of indium tin oxide being positioned on top of the EL phosphor.

6. The antireflection layer of claim 5, including an Al₂O₃ layer sandwiched between an outer surface of the ceramic sphere region and the EL phosphor layer.

7. The antireflection layer of claim 5, including an Al₂O₃ layer sandwiched between an outer surface of the EL phosphor layer and the indium tin oxide layer.

8. The antireflection layer of claim 5, including an Al₂O₃ layer sandwiched between an outer surface of the ceramic sphere region and the EL phosphor layer, and including an Al₂O₃ layer sandwiched between an outer surface of the EL phosphor layer and the indium tin oxide layer.

9. The antireflection layer of claim 8 wherein a thickness of the metal layer, the ITO layer and Al₂O₃ layers is adjusted to reduce diffuse reflectance light from top areas of the coated spheres.

10. The antireflection layer of claim 4, wherein the metal layer coating the polymer regions and ceramic sphere regions is gold.

11. The antireflection layer of claim 3, wherein the metal layer is chosen from gold or platinum.

12. The antireflection layer of claim 3, wherein the thickness of the metal layer and the thickness of the ITO layer are consistent over the entire surface of the SSTFEL device.

13. The antireflection layer of claim 2, wherein the flexible emissive EL device is a ceramic chip-based EL (nixel) device including a plurality of individual nixels assembled on a flexible substrate in an array to form said flexible emissive EL device.

14. The antireflection layer of claim 13, wherein the surface of the flexible emissive electroluminescent device comprises ceramic chip regions and polymer regions.

15. The antireflection layer of claim 14, wherein the ceramic chip regions are coated with phosphor, said layer of indium tin oxide being positioned on top of the EL phosphor.

16. The antireflection layer of claim 14, wherein the polymer regions are coated with gold.

17. The antireflection layer of claim 13, wherein the metal layer is chosen from gold or platinum.

18. The antireflection layer of claim 1, wherein the thickness of the metal layer and the thickness of the ITO layer are consistent over the entire surface of the flexible emissive EL device.

19. The antireflection layer of claim 18, wherein the metal layer is about 2 to about 16 nm thick.

20. The antireflection layer of claim 19, wherein the metal layer is about 3 to about 4 nm thick.

21. The antireflection layer of claim 18, wherein the thickness of the ITO layer and the metal layer are chosen to satisfy the conditions of destructive interference.

22. The antireflection layer of claim 18, wherein the ITO layer is about 40 to about 170 nm.

23. The antireflection layer of claim 22, wherein the ITO layer is about 42 to about 45 nm thick.

24. The antireflection layer of claim 1, wherein the antireflection layer is an electrode of the flexible emissive EL device.

25. The antireflection layer of claim 1, wherein the metal layer reflects at least a portion of ambient light incident on the flexible emissive EL device.

26. The antireflection layer of claim 25, wherein the portion of ambient light not reflected by the metal layer passes through the ITO layer.

27. The antireflection layer of claim 1 wherein a thickness of the metal layer and the ITO layers is adjusted to reduce diffuse reflectance light from top areas of the coated spheres.

28. The antireflection layer of claim 6 wherein a thickness of the metal layer, the ITO layer and Al₂O₃ layers is adjusted to reduce diffuse reflectance light from top areas of the coated spheres.

29. The antireflection layer of claim 7 wherein a thickness of the metal layer, the ITO layer and Al₂O₃ layers is adjusted to reduce diffuse reflectance light from top areas of the coated spheres.

30. The antireflection layer of claim 1, wherein the thickness of the ITO layer and the metal layer are chosen to satisfy a condition of destructive interference.

31. A method of forming an antireflection layer on a flexible emissive electroluminescent (EL) device, comprising the steps of:
preparing a flexible emissive EL device having an emissive surface;
depositing a layer of Indium-tin oxide (ITO) over the entire emissive surface of the EL device; and
depositing a layer of gold over the layer of ITO.

32. The method of claim 31, wherein the step of depositing a layer of ITO comprises sputtering a layer of ITO.

33. The method of claim 32, further comprising setting RF power, sputtering time, and chamber pressure selected to produce a predetermined ITO layer thickness.

34. The method of claim 31, wherein the thickness of the ITO layer is chosen to satisfy the conditions of destructive interference for the EL device.

35. The method of claim 31, wherein the step of depositing a layer of gold comprises sputtering a layer of gold.

36. The method of claim 31, wherein the flexible emissive EL device is a ceramic chip-based EL (nixel) device including a plurality of individual nixels assembled on a flexible substrate in an array to form said flexible emissive EL device.

37. The method of claim 31, wherein the flexible emissive EL device is a sphere supported thin film electroluminescent (SSTFEL) device, and wherein a surface of the flexible emissive EL device comprises ceramic sphere regions and polymer regions, and wherein the ceramic sphere regions are coated with an EL phosphor layer, said layer of ITO being located (perhaps positioned or deposited?) on top of the EL phosphor.

38. The method of claim 31, wherein the thickness of the ITO layer and the metal layer are chosen to satisfy a condition of destructive interference.
